(19) United States
(12) Patent Application Publication
(10) Pub. No.: US 2010/0142947 A1
(43) Pub. Date: Jun. 10, 2010

(54) APPARATUS AND METHOD FOR PSEUDO-INVERSE MULTIPLEXING/DE-MULTIPLEXING TRANSPORTING

(76) Inventors: Jong-yoon Shin, Daejeon-si (KR); Jong-ho Kim, Daejeon-si (KR); Je-soo Ko, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/632,588

(22) Filed: Dec. 7, 2009

(30) Foreign Application Priority Data
Dec. 8, 2008 (KR) 10-2008-0124171
Nov. 18, 2009 (KR) 10-2009-0111560

(51) Int. Cl. H04J 3/04; H04J 14/00

(52) U.S. Cl. 398/43; 370/535

(57) ABSTRACT

A pseudo-inverse multiplexing/de-multiplexing apparatus and method are disclosed. The pseudo-inverse multiplexing apparatus maps a client signal to an OPUk-Xpv signal. The OPUk-Xpv signal has a payload area that can be segmented into a plurality of tributary slots and an overhead area into which frame configuration information related to the tributary slots is inserted. The pseudo-inverse multiplexing apparatus decides the number of tributary slots to be used to map client signals, according to a bit rate or bit tolerance of the client signals, and maps the client signals using the determined number of tributary slots. Accordingly, it is possible to map or frame a variety of client signals.

### CROSS-REFERENCE TO RELATED APPLICATION

This application claims the benefit under 35 U.S.C. §119(a) of Korean Patent Applications No. 10-2008-124171, filed on Dec. 8, 2008 and No. 10-2009-111560, filed on Nov. 18, 2009, the disclosures of which are incorporated by reference in its entirety for all purposes.

### BACKGROUND

1. Field

The following description relates to inverse multiplexing for optical communications.

2. Description of the Related Art

An optical transport network (OTN) uses time division multiplexing to map client signals having various bit rates to a single high speed frame and transport it. However, if a client signal to be mapped has a bit rate higher than a transport signal, inverse multiplexing is used to map a tributary signal having a high bit rate to several transport signal frames having relatively low bit rates.

In view of signal capacity, the inverse multiplexing is basically to byte-interleave a large capacity of tributary signal into several container signals having small capacities.

The ITU-T G. 709 defines a group of signals each having a small capacity as an optical payload unit OPUk-Xv (k=1, 2 or 3, X is a virtual concatenation number, and v means virtual concatenation), an illustrative example of which is shown in FIG. 1. For example, a 2.5G-level virtual concatenated group may be defined as OPU1-Xv, a 10G-level virtual concatenated group may be defined as OPU2-Xv, and a 40G-level virtual concatenated group may be defined as OPU3-Xv.

Each OPUk signal of OPUk-Xv is divided into X OTUk signals through ODUk and OTUk mapping, and the X OTUk signals are transported to their final destinations individually via preset paths. At this time, skew generated between signals belonging to each VCAT group is estimated and compensated for, using a Multi-Frame Alignment Signal (MFAS) of the overhead (OH) of each OTUk, and a Multi-Frame Indicator (MFI) of the Virtual Concatenated Overhead (VCOH).

In the following description, it is assumed the case of mapping a 100GbE signal to OPU2e-10v. OPU2e is defined to bit-transparently map a 10GbE signal. Accordingly, since a 10GbE signal can be bit-synchronously mapped to OPU2e, a bit rate of the OPU2e payload area is 10,356,012 kbit/s (=238/237×10.3125 Gbit/s)±100 ppm. As a result, as illustrated in FIG. 2, 4×16 fixed stuff bytes is located from 1905^{th} to 1920^{th} columns. The OPU2e-10v is a virtual concatenated signal of 10 OPU2e signals, and accordingly a bit rate of the OPU2e-10v payload area reaches 103,560,126 kbit/s (=238/237×10.3125 Gbit/s×10)±100 ppm. Since the 100GbE signal has a bit rate of 103,125,000 kbit/s±100 ppm, 4×10×16 fixed stuff bytes are used to bit-synchronously map the 100GbE signal to OPU2e-10v, which is illustrated in FIG. 3. That is, a transport terminal needs to bit-transparently map a 100GbE signal to OPU2e-10v and a reception terminal has to be able to extract the 100GbE signal from the OPU2e-10v. Accordingly, in order to map different bit rates of tributary signals, the number and location of fixed stuff bytes need to be newly defined. That is, in order to map a tributary signal having a different bit rate while maintaining the number of fixed stuff bytes as shown in FIG. 3, a new bit rate, instead of OPU2e-10v, has to be defined in proportion to the bit rate of the tributary signal.

Meanwhile, if a bit tolerance of the tributary signal to be mapped is ±100 ppm, a bit tolerance of OPU2e-10v after synchronous mapping also has to be ±100 ppm. In other words, since the bit rate, bit tolerance and number of fixed stuff bytes of OPU2e-10v depend on the capacity of tributary signals to be mapped, variations in capacity of tributary signals to be mapped has to be accompanied by correcting at least one of the bit rate, the bit tolerance and the number of fixed stuff bytes. In short, a predetermined bit rate, a predetermined bit tolerance and a predetermined number of fixed stuff bytes are dedicated to map only tributary signals with the same capacity. Furthermore, it is impossible to simultaneously map two or more client signal types coming from different networks.

FIG. 4 is a view for explaining transport of OPU2e-10v.

In FIG. 4, a 100GbE signal is mapped to 10 virtual concatenated OPU2e-10v signals, to thus finally generating 10 OTU2e signals. The 10 OTU2e signals are transported through a 10×10G optic module. As described above, OPU2e-10v can map a type of a tributary signal having a bit rate lower than 103,560,126 kbit/s±100 ppm, which is synchronized to OPU2e-10v.

However, it is inefficient that OPU2e-10v maps different client signals except 100GbE signals. For example, it is assumed the case of mapping a 40GbE signal to OPU2e-10v. Since the capacity of the payload of OPU2e-10v is about 2.5 times larger than that of the 40GbE signal, mapping a 40GbE signal to an OPU2e-10v signal is inefficient. That is, in this case, about 60% bytes remaining after mapping to OPU2e-10v are filled with fixed stuff bytes since OPU2e-10v can map only one client signal.

FIG. 5 shows an OPU2e-10v structure when a 40GbE signal is mapped. OPU2e-10v has a capacity that can map 2 40GbE signals and 2 10GbE signals. Nevertheless, OPU2e-10v can neither distinguish different types of tributary signals from each other nor simultaneously map a plurality of tributary signals having different bit rates since it has the frame structure illustrated in FIG. 1, only allowing inverse-multiplexing of a single large capacity of tributary signal into small capacities of transport signals.

Accordingly, another method is needed to map 40GbE signals.

One of such methods is to use OPU2e-4v to map 40GbE signals. However, in this case, since OPU4e-4v is a 40G-level signal, there is limitation to have to replace a 100G-level optic module with a 40G-level optic module. Furthermore, in order to transport two 40GbE signals and two 10GbE signals, two OPU2e-4v signals and two OPU2e signals have to be generated independently. This means that different bit rates or two 40G-level optic modules and two 10G-level optic modules that are not synchronized to each other have to be used. That is, it is impossible to transport even a 100G-level tributary signal through a single 100G optic module.

Another method is to map two 40GbE signals and two 10GbE signals to a larger capacity of OPU4 signal. However, since an OPU4 signal has a fixed payload capacity of about 100G not so as to map any tributary signal more than 100G, there is a problem that a new frame and a new multiplexing method have to be defined whenever to map tributary signals more than 100G.

As a result, when an OPU2e-10v line card based on inverse multiplexing is manufactured to map 100GbE signals, only 100GbE signals can be processed through the OPU2e-10v line card. That is, in the case of having to transport 100G while mapping 40GbE and 10GbE signals, another method has to be used and accordingly a separate line card is required.

### SUMMARY

According to an exemplary aspect, there is provided a pseudo-inverse multiplexing apparatus including: a frame setting unit to determine a type of a tributary slot to map a client signal and to segment a virtual concatenated optical channel payload unit (OPUk-Xpv) into at least one tributary slot according to the determined tributary slot type; a payload generator to map a received client signal to a payload of the OPUk-Xpv, using the tributary slot; and an overhead generator to generate frame configuration information related to the tributary slot and to insert the frame configuration information into an overhead of the OPUk-Xpv.

The frame setting unit segments the OPUk-Xpv into an OPUk-Xv tributary slot that is segmented in units of a predetermined number of bytes, into X OPUk tributary slots each of which is segmented into a predetermined number of 1.25G tributary slots, or into a plurality of 1.25G tributary slots.

A capacity of the tributary slot and the predetermined unit of bytes are determined according to a level k of the OPUk-Xpv.

The payload generator decides the number of tributary slots needed to map the client signal, according to a bit rate or a bit tolerance of the client signal, or allocates received client signals to different tributary slots.

The frame configuration information includes at least one among the determined tributary slot type, the number of tributary slots used for mapping, justification control information and timing control information.

According to another exemplary aspect, there is provided a pseudo-inverse multiplexing method including: determining a type of a tributary slot to map a client signal, and segmenting a virtual concatenated optical channel payload unit (OPUk-Xpv) into at least one tributary slot based on the determined tributary slot type; mapping a received client signal to a payload of the OPUk-Xpv using the tributary slot; and generating frame configuration information related to the tributary slot and inserting the frame configuration information into an overhead of the OPUk-Xpv.

According to another exemplary aspect, there is provided a pseudo-inverse de-multiplexing apparatus including: an overhead detection unit to detect a type and number of tributary slots to which client signals have been mapped, using an overhead of a received virtual concatenated optical channel payload unit (OPUk-Xpv); a payload segmentation unit to segment the OPUk-Xpv into the tributary slots according to the detected type and number of the tributary slots; and a demapping unit to detect the client signals according to the tributary slots.

According to another exemplary aspect, there is provided a pseudo-inverse de-multiplexing method including: detecting a type and number of tributary slots to which client signals have been mapped, using an overhead of a received, virtually concatenated optical channel payload unit OPUk-Xpv; segmenting the OPUk-Xpv into the tributary slots based on the detected type and number of the tributary slots; and detecting the client signals according to the tributary slots.

Other objects, features and advantages will be apparent from the following description, the drawings, and the claims.

### BRIEF DESCRIPTION OF THE DRAWINGS

FIG. 1 shows an exemplary OPUk-Xv frame structure.

FIGS. 2 and 3 show fixed stuff bytes of an OPUk-Xv frame.

FIG. 4 shows a configuration of a transporter for OPU2e-10v transport.

FIG. 5 shows an exemplary payload of OPU2e-10v when a 40GbE signal is mapped.

FIG. 6 shows an exemplary OTUk frame structure.

FIG. 7 shows an exemplary virtual concatenated overhead structure.

FIG. 8 is a view for explaining OPU2e-10pv transport according to an exemplary embodiment.

FIGS. 9 through 13 are views for explaining OPUk-3pv transport according to exemplary embodiments.

FIG. 14 shows a configuration of an exemplary pseudo-inverse multiplexer.

FIGS. 15 through 18 show OPUk-Xpv frame structures using OPUk-Xv tributary slots according to exemplary embodiments.

FIGS. 19 through 21 show OPUk-Xpv frame structures using OPUk tributary slots according to exemplary embodiments.

FIGS. 22 through 27 show OPUk-Xpv frame structures using 1.25G tributary slots according to exemplary embodiments.

FIG. 28 shows an exemplary overhead structure of OPUk-Xpv using OPUk tributary slots.

FIG. 29 shows a Pseudo Multiplex Structure Identifier (PMSI) structure of OPUk-Xpv using OPUk tributary slots according to an exemplary embodiment.

FIG. 30 shows an OPU2E-10pv frame using OPU2e tributary slots according to an exemplary embodiment.

FIG. 31 shows a MSI byte of OPUk-Xpv using OPUk tributary slots.

FIGS. 32 through 37 show examples of PMSI coding of OPUk-Xpv using OPUk tributary slots.

FIGS. 38 through 41 show examples where tributary slots are mapped in OPU2e-10pv.

FIG. 42 is a block diagram illustrating a configuration of an exemplary pseudo-inverse de-multiplexer.

FIG. 43 illustrates interfaces between a pseudo-inverse multiplexer and an optical transporter, according to an exemplary embodiment.

FIGS. 44A through 44D are a flowchart illustrating a pseudo-inverse multiplexing method according to an exemplary embodiment.

FIGS. 45A through 45D are a flowchart illustrating a pseudo-inverse de-multiplexing method according to an exemplary embodiment.

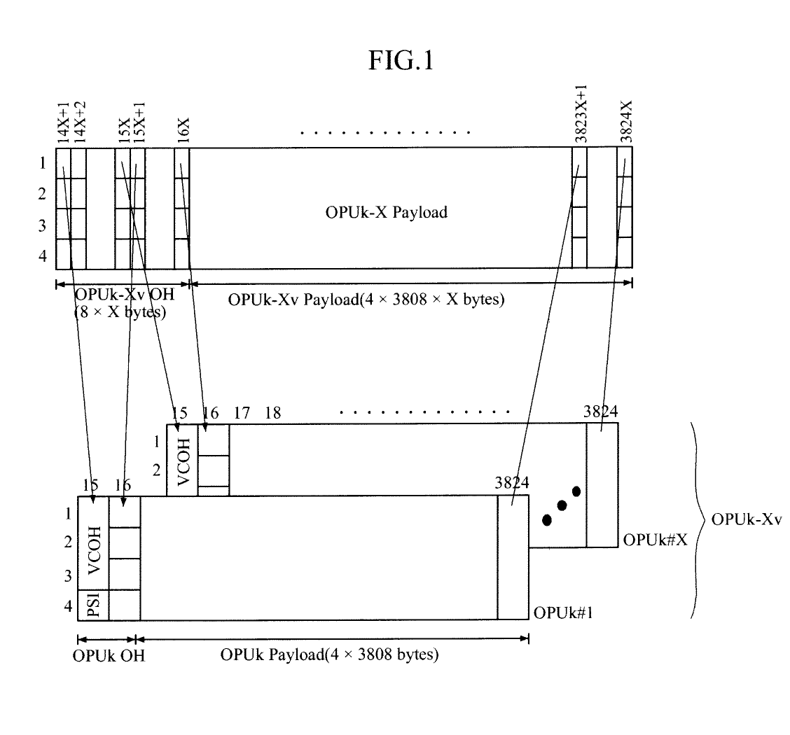

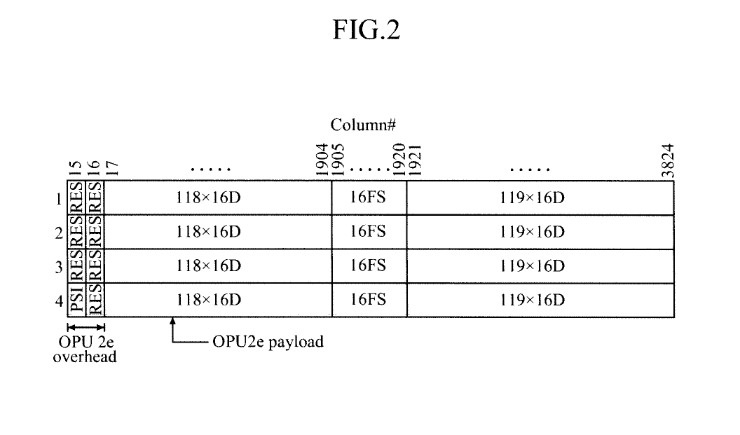

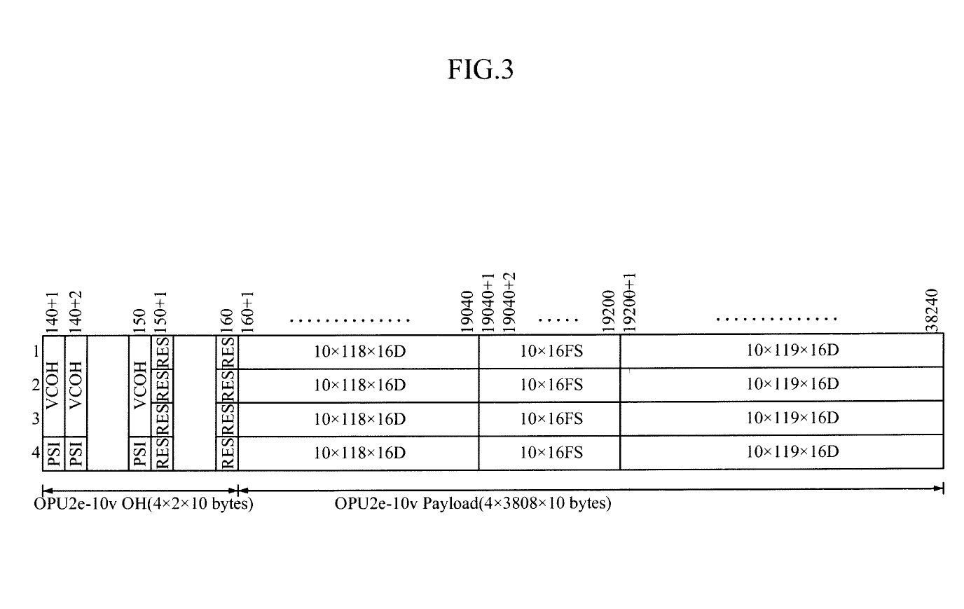

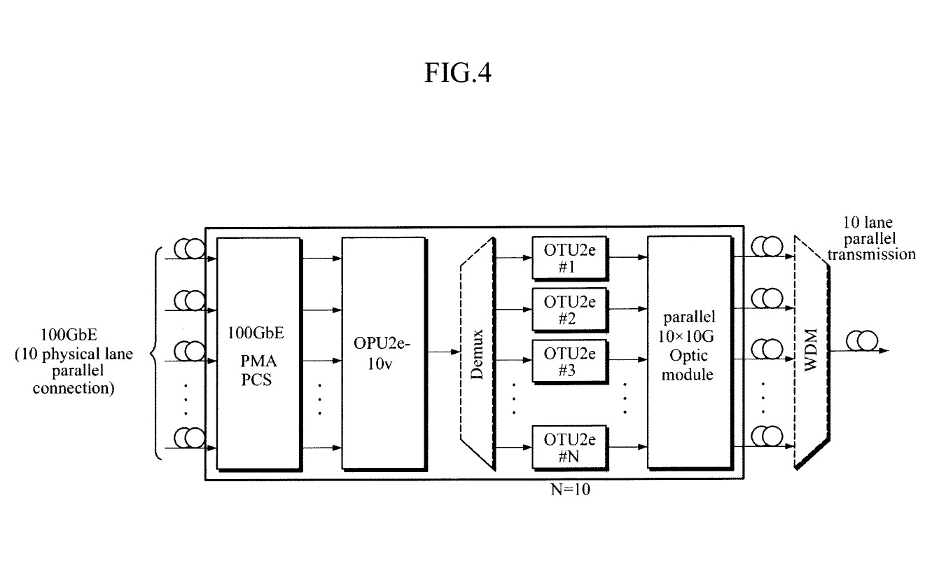

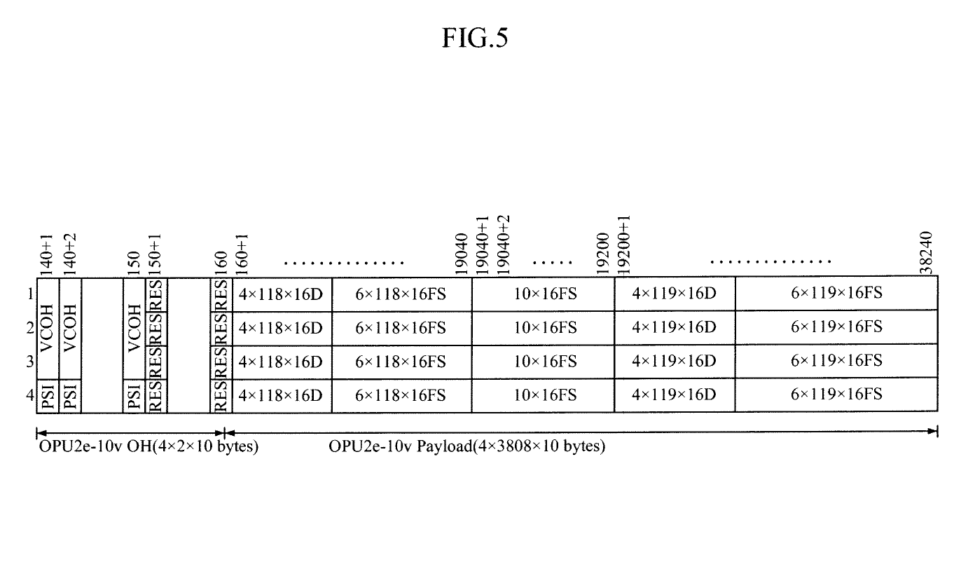

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

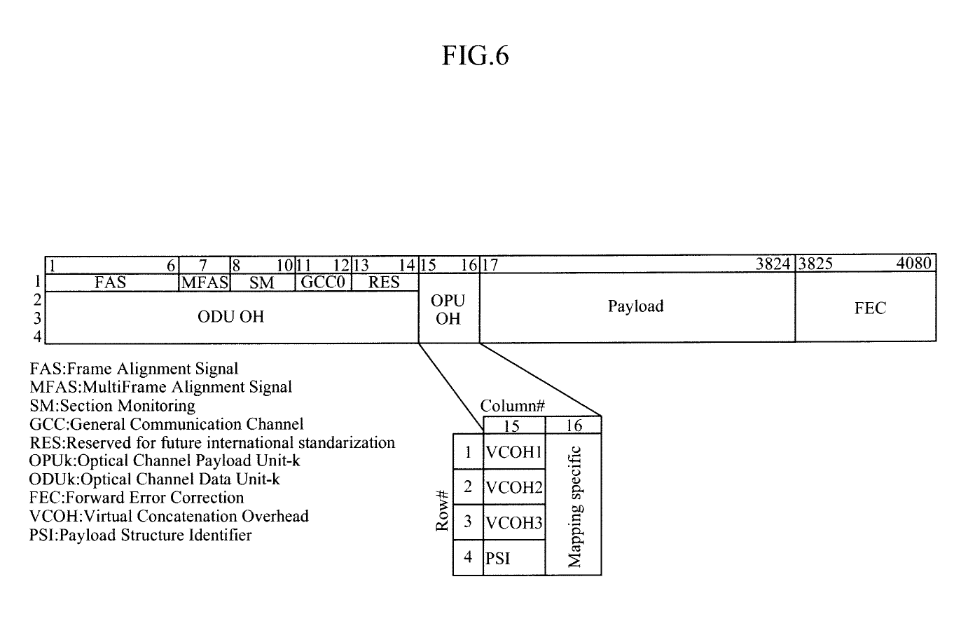

FIG. 6 shows an exemplary OTUk frame structure.

Referring to FIG. 6, the 15^{th} and 16^{th} columns of the OTUk frame correspond to an overhead. In the OTUk overhead, a Payload Structure Identifier (PSI) specifying a payload type is located at bytes on the 4^{th} row of the 15^{th} column. Bytes of the 16^{th} column define an overhead required to map client signals to the OPUk payload. In the case of transporting a virtual concatenated signal, virtual concatenated overheads are additionally located at 3 bytes on the 1^{st} to 3^{rd} rows of the 15^{th} column.

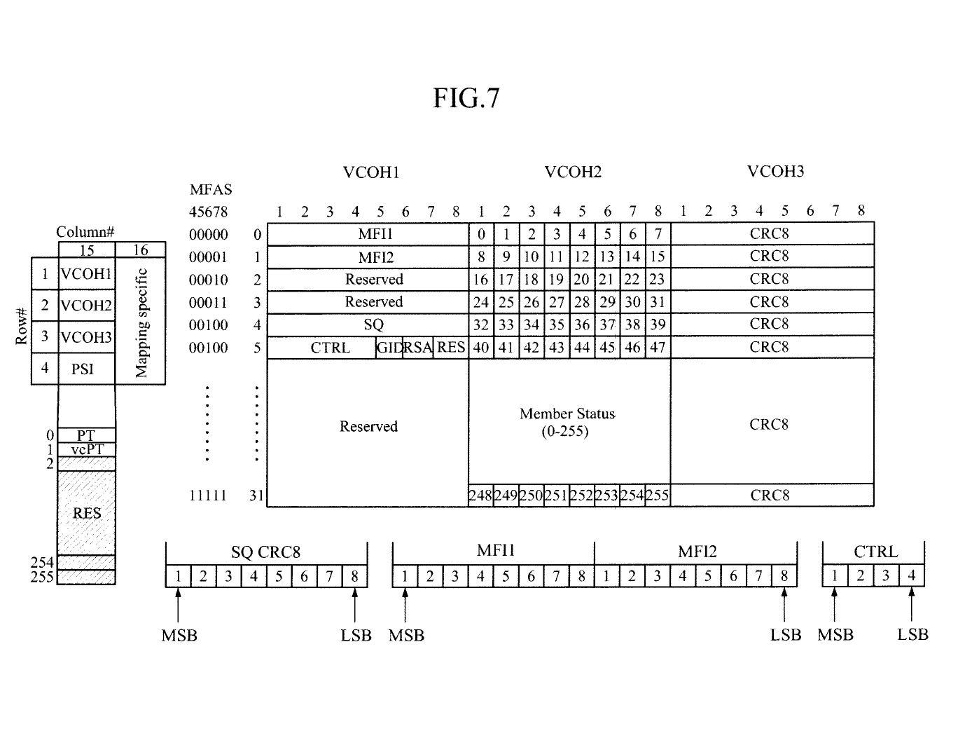

FIG. 7 shows an exemplary virtual concatenated overhead structure.

Referring to FIG. 7, a PSI of OPUk overheads includes 256-byte information. The first byte PSI[0] of the PSI bytes is an OPUk payload type (PT) byte to specify a payload type of OPUk. The second byte PSI[1] of the PSI bytes is a virtual concatenated OPUk-Xv payload type (VcPT) byte to specify a payload type of the virtual concatenated signal.

VCOH (denoted by VCOH1, VCOH2 and VCOH3 in FIG. 7) areas each may include 32-byte information using multi-frame information. Virtual Concatenation Multi-frame Identicator (MFI) bytes have multi-frame identifiers for virtual containers, other than MFAS bytes, to extend maximally upto 16 bits, and consequently can identify maximally 16,777,216 ODUk frame lengths, including MFAS bytes. A sequence indicator (SQ) byte specifies a sequence number for X virtual containers in the OPUk-Xv. Accordingly, the virtual containers may be distinguished by the SQ byte.

The remaining bytes, that is, CTRL (Control word from source to sink), GID (Group Indentification), RSA (Re-sequence Acknowledge), etc. are used.

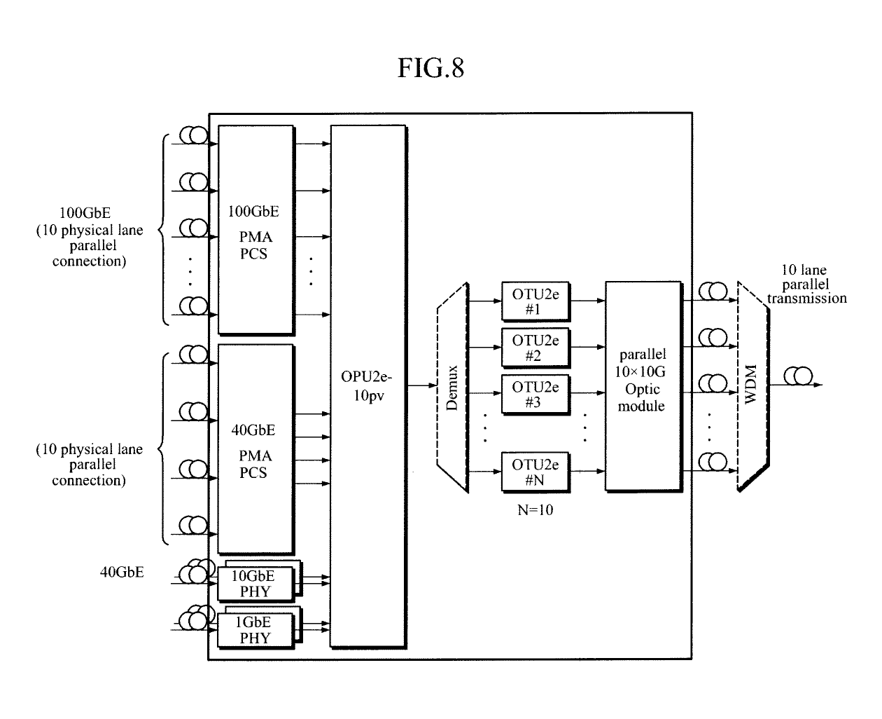

FIG. 8 is a view for explaining OPU2e-10pv transport according to an exemplary embodiment.

In the current embodiment, a pseudo-inverse multiplexed signal will be referred to as

“OPUk-Xpv” in order to distinguish it from a general inverse multiplexed signal “OPUk-Xv”. Here, the OPUk-Xpv represents a virtual concatenated optical-channel payload unit, wherein k represents a level of the optical-channel payload unit and X represents a virtual concatenation number.

In the embodiment illustrated in FIG. 8, a 100GbE signal, or two 40GbE signals and two 10GbE signals can be mapped to an OPU2e-10pv signal. Likewise, it is also possible to map a 40GbE signal and six 10GbE signals, or 80 1GbE signals to an OPU2e-10pv signal.

The OPU2e-10pv signal is finally converted into 10 OTU2e signals. The 10 OTU2e signals are transported through a 10×10G optic module.

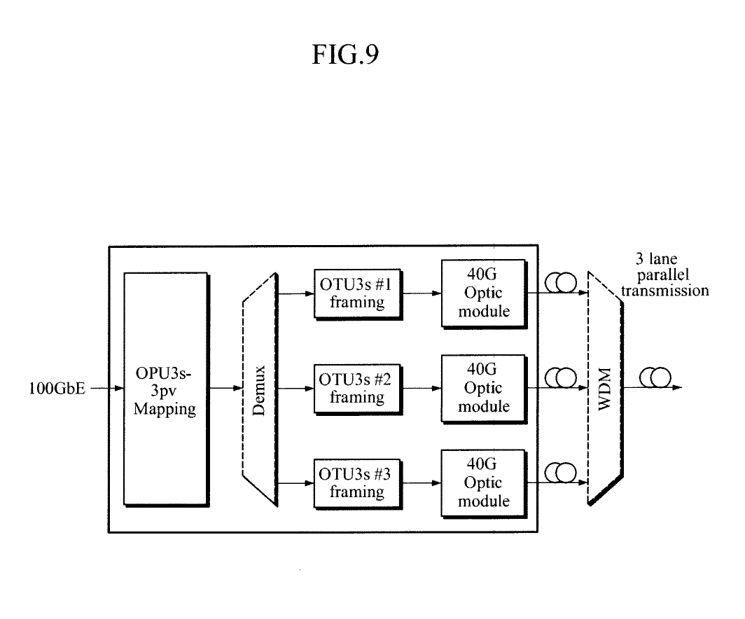

FIGS. 9 through 13 are views for explaining OPUk-3pv transport (k=3s, 3s2, 3, 3e) according to exemplary embodiments.

In the embodiments of FIGS. 9 through 13, a signal with a minimum bit rate to bit-transparently map a 100GbE signal among OPUk-3pv is referred to as OPU3s-3pv. FIG. 9 relates to an example of transporting an OPU3s-3pv signal capable of mapping a 100GbE signal through 3 40G optic modules. The bit rate of OPU3s-3pv is about 110.504 330 622 327 Gbit/s±20 ppm. Meanwhile, a minimum bit rate to bit-transparently map a 100GE signal to an OTU4 frame is 110.736 971 318 374 Gbit/s±20 ppm. As described above, the OTU4 based method is inefficient because of having to allocate 8 bytes of 4080 bytes of OTU4 to fixed stuff bytes, and accordingly the OPU3s-3pv based method can bit-transparently map a 100GbE signal efficiently at a lower bit rate than the OTU4 based method. Here, each 40G optic module may have transmission performance that is higher than about 36.835 Gbit/s. The OPU3s-3pv is finally converted into 3 OTU3s signals. The 3 OTU3s signals are transported through 3 multi-wavelength optical fibers via 3 40G optic modules.

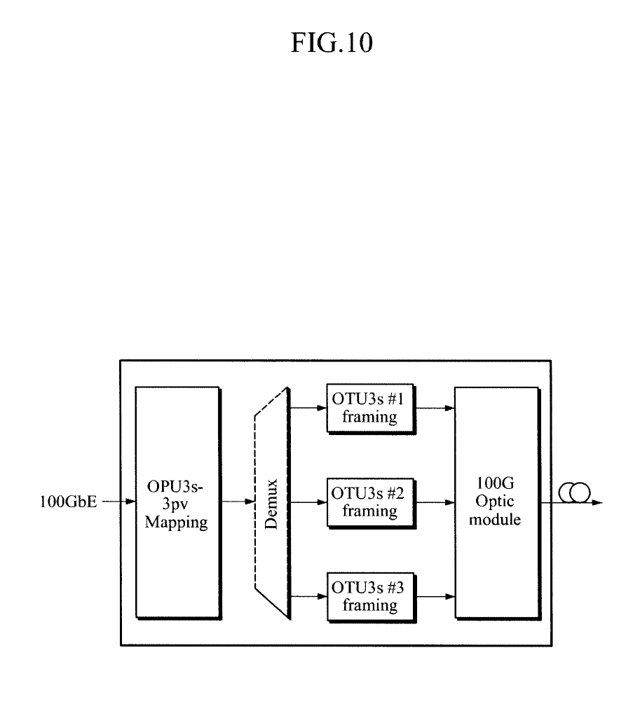

FIG. 10 relates to an example of transporting an OPU3s-3pv signal capable of mapping a 100GbE signal through a single 100G optic module. The bit rate of an OTU4 optic module is about 118.099 735 682 819 Gbit/s±20 ppm and OPU3s-3pv has a bit rate of 110.504 330 622 327 Gbit/s±20 ppm that is lower than the bit rate of the OTU4 optic module. Accordingly, it is possible to transport an OPU3s-3pv signal through a 100G optic module, instead of through three 40G optic modules.

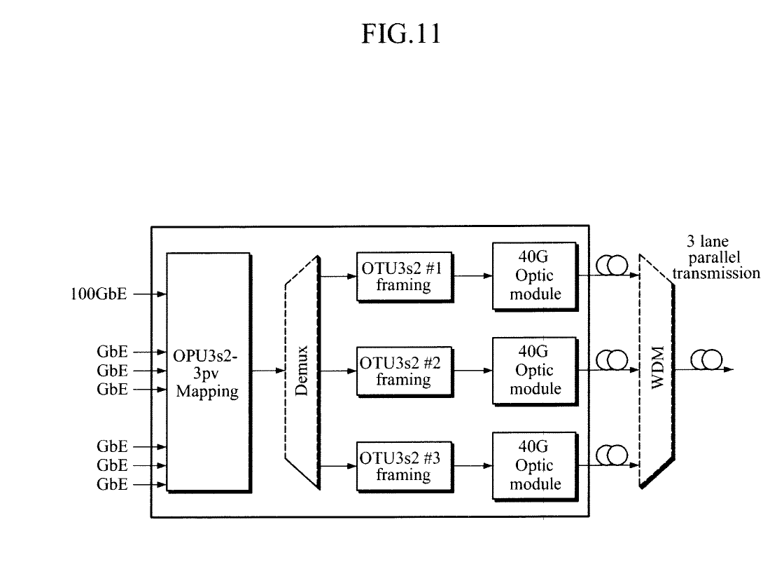

Hereinafter, an OTUk signal having the same bit rate as a STM-256 signal is referred to as OTU3s2, and a signal created by performing pseudo-inverse multiplexing on three OTU3s2 signals is referred to as OPU3s2-3pv. FIG. 11 relates to an example of transporting an OPU3s2-3pv signal through 3 40G optic modules. Since the bit rate of OTU3s is 39.81312 Gbit/s±20 ppm, the bit rate of OPU3s2-3pv is 119.43936 Gbit/s and each 40G optic module may have transmission performance that is higher than 39.81312 Gbit/s. The OPU3s2-3pv signal is converted into 3 OTU3s2 signals. The 3 OTU3s2 signals are transported through 3 multi-wavelength optical fibers via 3 40G optic modules. An OPU3s2-3pv signal can use maximally 96 1.25G tributary slots. In order to map a 100GbE signal, an OPU3s2-3pv signal may use 90 1.25G tributary slots, and simultaneously may map 6 1GbE signals using the remaining 6 1.25G tributary slots. That is, OPU3s-3pv may map maximally 6 1GbE signals additionally while mapping a 100GbE signal. Also, OPU3s-3pv may be resulted from pseudo-inverse multiplexing of maximally one 100GbE signal or maximally 96 1GbE signals.

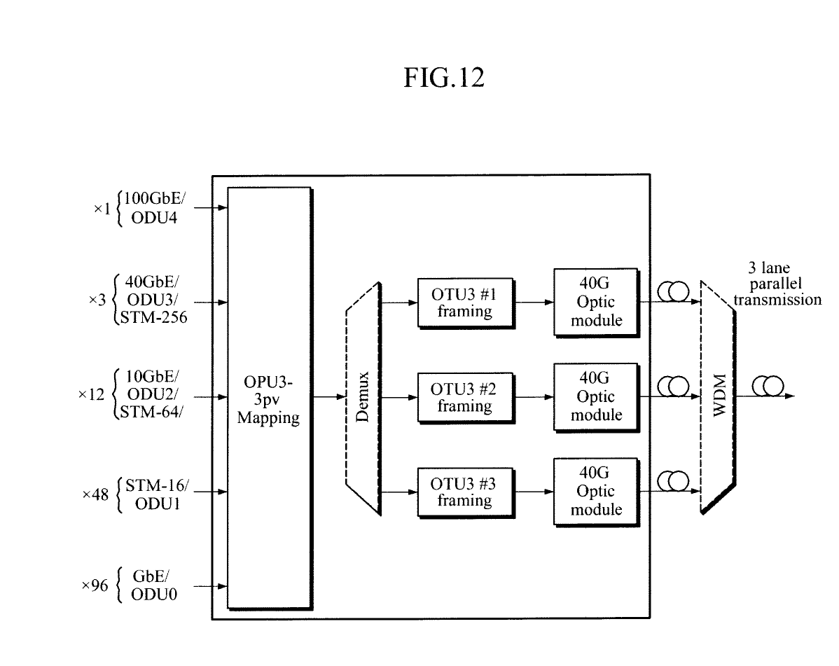

The bit rate of OTU3 is about 43.018 413 559 322 Gbit/s (=255/236×39.81312 Gbit/s)±20 ppm. A signal obtained by performing pseudo-inverse multiplexing on 3 OTU3 signals is referred to as OPU3-3pv. FIG. 12 relates to an example of transporting an OPU3-3pv signal through 3 40G optic modules. The bit rate of an OPU3-3pv signal is about 129.055 240 677 966 Gbit/s±20 ppm and each 40G optic module may have transmission performance that is higher than 43.0185 Gbit/s. The OPU3-3pv signal is finally converted into 3 OTU3 signals. The 3 OPU3 signals are transported through 3 multi-wavelength optical fibers via 3 40G optic modules. The OPU3-3pv signal can use maximally 96 1.25G tributary slots. In order to map a 100GbE signal, an OPU3-3pv signal may use 83 1.25G tributary slots, and simultaneously may map 13 1GbE signals using the remaining 13 1.25G tributary slots. That is, OPU3-3pv may map maximally 13 1GbE signals additionally while mapping a 100GbE signal. Also, the OPU3-3pv is resulted from pseudo-inverse multiplexing of maximally one 100GbE/ODU4 signal, maximally 96 1GbE/ODU0 signals, maximally 48 STM-16/ODU1 signals, 12 10GbE/ODU2/STM-64 signals, or 3 40GbE/ODU3/STM-256 signals. A great difference in performance between OPU3s2-3v and OPU3-3v is in that the OPU3s2-3v can map maximally 2 40GbE/ODU3/STM-256 signals whereas the OPU3-3v can map maximally 3 40GbE/ODU3/STM-256 signals.

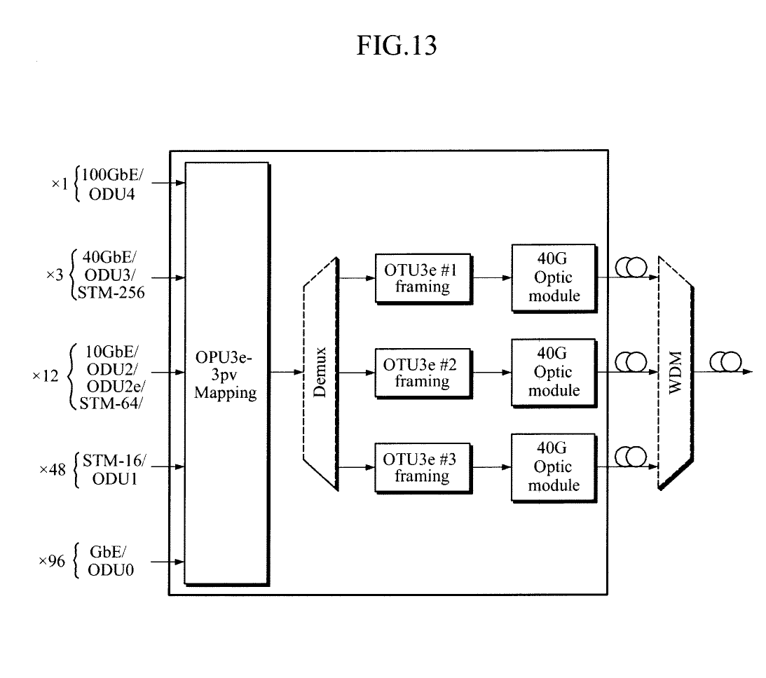

It is assumed that a bit rate of OTU3e is 44.5824 (=215/192×39.81312) Gbit/s±20 ppm. A signal obtained by performing pseudo-inverse multiplexing on 3 OTU3e signals is referred to as OPU3e-3pv. FIG. 13 relates to an example of transporting an OPU3e-3pv signal through 3 400 optic modules. The bit rate of the OPU3e-3pv signal is 133.7472 Gbit/s±20 ppm and each 40G optic module may have transmission performance that is higher than 44.5824 Gbit/s. The OPU3e-3pv is finally converted into 3 OTU3e signals. The 3 OTU3e signals are transported through 3 400 optic modules. The OPU3e-3pv signal may use maximally 96 1.25G tributary slots. In order to map a 100GbE signal, the OPU3e-3pv signal may use 80 1.25G tributary slots, and simultaneously may map 16 1GbE signals using the remaining 16 1.25G tributary slots. That is, the OPU3e-3pv may map maximally 16 1GbE signals additionally while mapping a 100GbE signal. Also, since OPU3e-3pv can map a 10GE signal using 8 1.25G tributary signals, OPU3e-3pv can map maximally 2 10GbE signals additionally while mapping a single 100GbE signal. Also, the OPU3e-3pv may be resulted from pseudo-inverse multiplexing of maximally one 100GbE/ODU0 signal, maximally 96 1GbE/ODU0 signals, maximally 48 STM-16/ODU1 signals, maximally 12 10GbE/ODU2/ODU2e/STM-64 signals or 3 40GbE/ODU3/STM-256 signals. A great difference in performance between OPU3-3v and OPU3e-3v is in that the OPU3-3v can map maximally 10 ODU2e signals whereas the OPU3e-3v can map maximally 12 ODU2e signals. ODU2e has a bit rate of 10,399,525 (=239/237×10.3125) kbit/s±100 ppm.

FIGS. 9 through 13 show examples where 3 OTUk optic modules are utilized. However, instead of 3 OTUk optic modules, it can be utilized a single 1200-level optic module based on a modulation method of transmitting 3 data bits as one symbol, for example, 8-level Phase Shift Keying (8-PSK), Differential Phase Shift Keying & 4-level Amplitude Shift Keying (DPSK-4ASK) or Differential Quadrature Phase Shift Keying & 2-level Amplitude Shift Keying (DQPSK-2ASK).

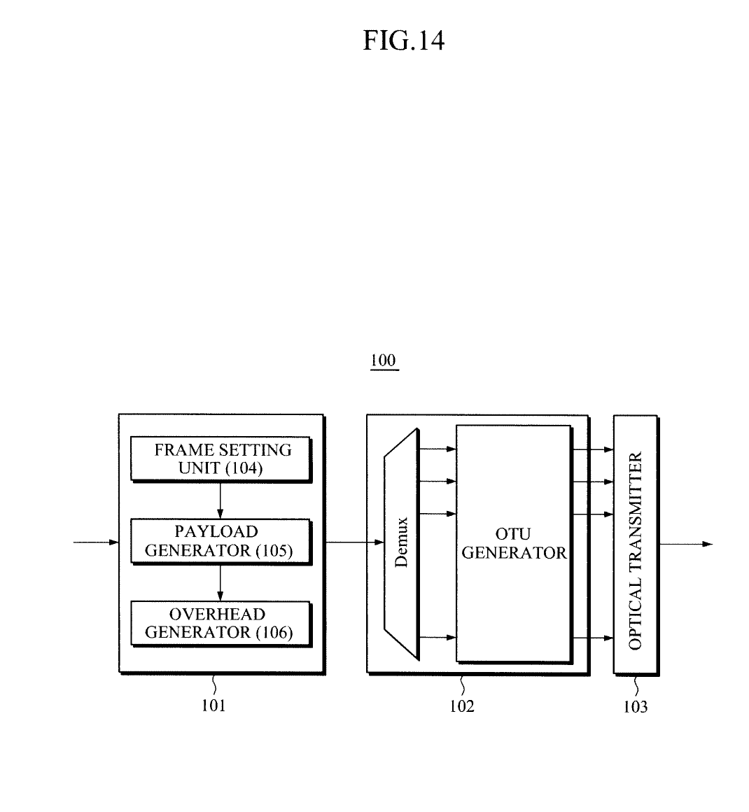

FIG. 14 shows a configuration of an exemplary pseudo-inverse multiplexer 100.

Referring to FIG. 14, the pseudo-inverse multiplexer 100 includes a first processor 101, a second processor 102 and an optical transporter 103.

The first processor 101 generates the OPU2e-10pv frame as illustrated in FIG. 8. The second processor 102 generates the OTU2e signals as illustrated in FIG. 8. The optical transporter 103 corresponds to the parallel 10×10G optic module illustrated in FIG. 8. That is, the first processor 101 receives client signals and frames the client signals to generate an OPUk-Xpv frame. The second processor 102 divides the OPUk-Xpv frame into OPUk frames and inserts OTU or ODU overheads into the respective ODUk frames, thus generating OTU signals. The optical transporter 103 transports the OTU signals to an optical transport network (OTN).

In more detail, the first processor 101 may include a frame setting unit 104, a payload generator 105 and an overhead generator 106.

The frame setting unit 104 sets a level k and a virtual concatenation number X for an OPUk-Xpv frame, and segments a payload area of the OPUk-Xpv frame into a plurality of tributary slots. The tributary slots may be at least one among a single OPUk-Xv tributary slot, X OPUk tributary slots and a plurality of 1.25G tributary slots. The OPUk-Xpv frame may include two or more types of tributary slots.

First, if the frame setting unit 104 uses a single OPUk-Xv tributary slot, the frame setting unit 104 segments the OPUk-Xv tributary slot in units of M bytes according to the k level. Then, the client signals are mapped to the OPUk-Xu tributary slots in units of M bytes.

For example, when k is 1, the frame setting unit 104 segments an OPUk-Xv tributary slot in units of 2 bytes. The number of the resultant segmented units each being allocated 2 bytes is 7616*X (=4×3808×X/2). If k is 2 or 2e, an OPUk-Xv tributary slot is segmented in units of 8 bytes, and accordingly the number of the resultant segmented units each being allocated 8 bytes is 1904*X (=4×3808×X/8). Also, if k is 3 or 3e, an OPUk-Xv tributary slot is segmented in units of 32 bytes (M=32), and accordingly the number of the resultant segmented units each being allocated 32 bytes is 476*X (=4×3808×X/32). If k is 4, an OPUk-Xv tributary slot is segmented in units of 80 bytes, and accordingly the number of the resultant segmented units each being allocated 80 bytes is 190*X (=4×3808×X/80).

Second, if the frame setting unit 104 uses X OPUk tributary slots, the frame setting unit 104 segments an OPUk-Xpv frame into X OPUk tributary slots according to the virtual concatenation number X. Each OPUk tributary slot may map one client signal thereto or may be segmented into a predetermined number of 1.25G tributary slots according to the k level to map a plurality of client signals using the 1.25G tributary slots.

For example, when an OPUk-Xpv frame is segmented into X OPUk tributary slots, if k is 1, each OPUk tributary slot may be segmented into 2 1.25G tributary slots, and if k is 2 or 2e, each OPUk tributary slot may be segmented into 8 1.25G tributary slots. Also, if k is 3 or 3e, each OPUk tributary slot may be segmented into 32 1.25G tributary slots, and if k is 4, each OPUk tributary slot may be segmented into 80 1.25G tributary slots.

Third, if the frame setting unit 104 uses a plurality of 1.25G tributary slots, the frame setting unit 104 segments an OPUk-Xpv frame into a plurality of 1.25G tributary slots to map a plurality of client signals using the 1.25G tributary slots. The number of 1.25G tributary slots may be properly set according to the k level.

For example, if k is 1, the number of 1.25G tributary slots may be 2X, and if k is 2 or 2e, the number of 1.25G tributary slots may be 8X. Also, if k is 3 or 3e, the number of 1.25G tributary slots may be 32X, and if k is 4, the number of 1.25G tributary slots may be 80X.

The payload generator 105 receives a client signal to be mapped to the payload area of the OPUk-Xpv frame, and decides the number of tributary signals required to map the client signal according to a bit rate or bit tolerance of the client signal.

For example, in the case of using OPUk tributary slots, a 10GbE client signal may be mapped using one OPU2e tributary slot, and a 40GbE client signal may be mapped using 4 OPU2e tributary slots. In the case of using 1.25G tributary slots in an OPU2e-10v frame, the number of 1.25G tributary slots is 80, and a 10GbE client signal may be mapped using at least 8 1.25G tributary slots. A 40GbE client signal may be mapped using at least 32 1.25G tributary slots.

The payload generator 105 maps the received client signal to the payload area using the decided number of tributary slots. When receiving a plurality of client signals, the payload generator 105 may allocate different tributary slots to the respective client signals. If justification occurs when mapping the client signals to the payload area, JC (Justification Control) information has to be generated and transported to a receiving terminal so that the receiving terminal can control the justification. If more accurate time information control is required, TC (Timing Control) information is generated and transported to the receiving terminal.

The overhead generator 106 inserts frame configuration information related to the tributary slots into the overhead areas of the OPUk-Xpv frame. Here, the frame configuration information may include the decided type of tributary slots, the number of tributary slots used for the mapping, justification control information, timing control information, etc. For example, if OPUk tributary slots are used, a PMSI which is defined using reserved bytes of a virtual concatenation overhead (VCOH) of the OPUk-Xv frame may be inserted as frame configuration information.

Also, the overhead generator 106 may insert the PMSI into overhead areas corresponding to OPUk tributary slots to which the same type of client signals has been mapped. In addition, to the overhead generator 106 may correct the PSI areas and VCOH areas properly.

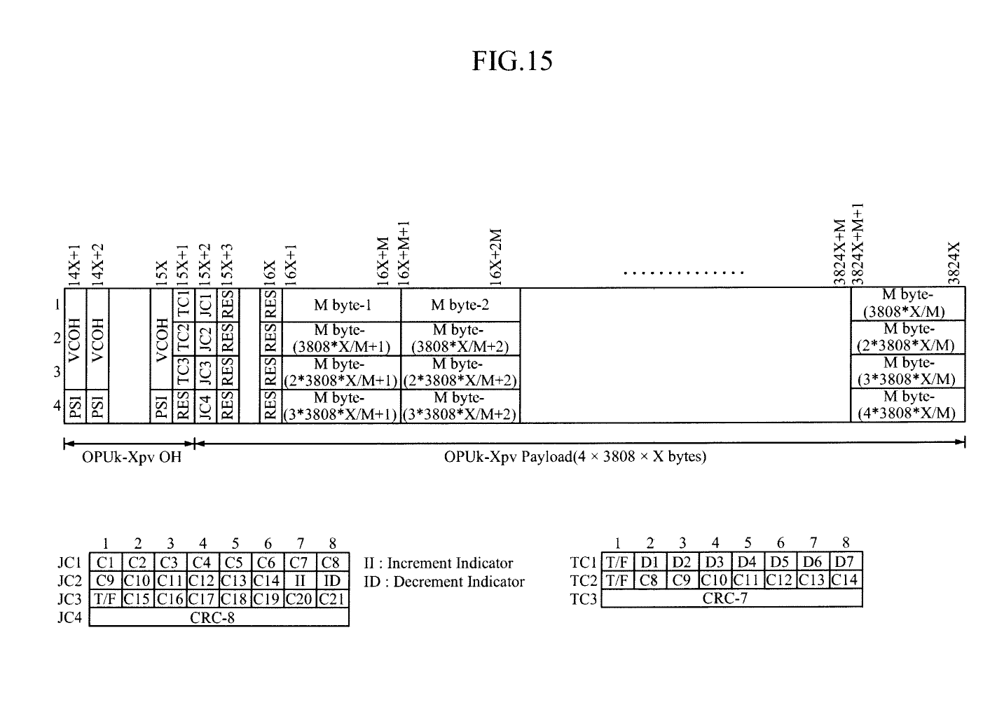

FIGS. 15 through 18 show OPUk-Xpv frame structures using OPUk-Xv tributary slots according to exemplary embodiments.

Referring to FIG. 15, OPUk-Xpv includes an OPUk-Xv tributary slot that is segmented in units of M bytes. Since the OPUk-Xv tributary slot has totally 4×3808×X bytes, the number of M-byte units is 4×3808×X/M. Likewise, in the overhead areas, there are VCOH, PSI, JC, TC, etc. Here, the “M” value and the number of M-byte units depend on a level k, as follows.

TABLE 1

| K Value | M Value | Total Number of M-byte Units for OPUk-Xv TS | |
|---|---|---|---|
| 1 | 2 | 7616*X | (=4*3808*X/2) |
| 2, 2e | 8 | 1904*X | (=4*3808*X/8) |
| 3, 3e | 32 | 476*X | (=4*3808*X/32) |
| 4 | 80 | 190*X | (=4*3800*X/80) |

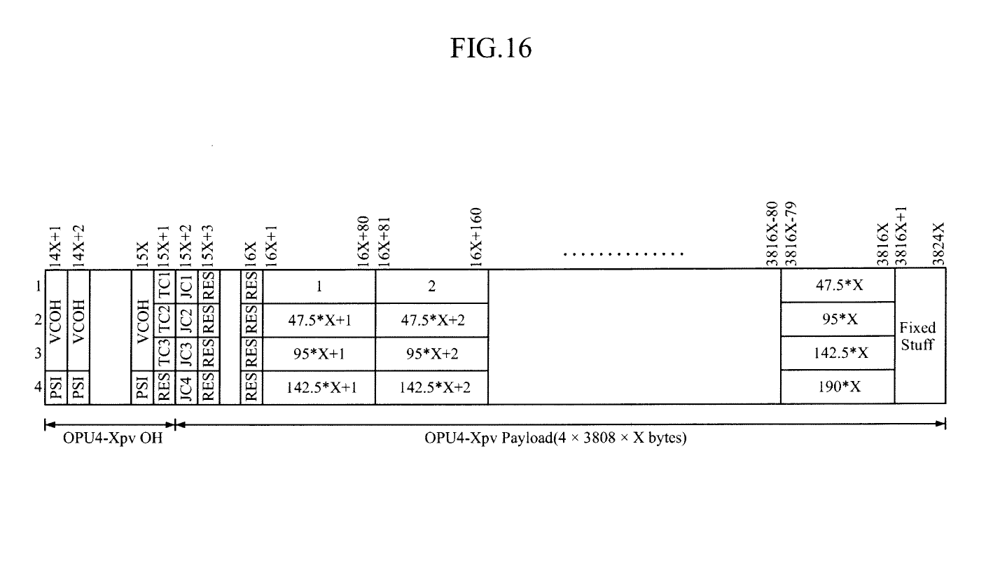

If k=4, since 4*3808 is not a multiple of the M value (80), 8 columns of 3808 columns are allocated to fixed stuff bytes and the remaining 3800 columns are allocated to M-byte units. Accordingly, as illustrated in FIG. 16, a total number of M-byte units for OPU4-Xv is 190*X (=4×3800×X/80).

In the case of using an OPUk-Xv tributary slot, since the OPUk-Xv tributary slot maps only one client signal, JC and TC information is also provided only for the client signal. That is, a total number Cm of M-byte units needed to map a client signal to an OPUk-Xv tributary slot is included in JC information and sent to a receiving terminal. Also, in order to compensate for the total number Cm of M-byte units and a total number Cn of bits to have to be substantially sent to map a client signal, a difference CnD between the Cn and Cm values also is included in TC information and sent. Since the maximum of the total number of M-byte units is 7616*X to and the X value is maximally 256, the number of bits needed to indicate the total number of M-byte units will be sufficient to be 21. A bit indicating that the number of M-byte units is incremented by 1 is an Increment Indicator (II) bit and a bit indicating that the number of M-byte units is decremented by 1 is a Decrement Indicator (DI) bit. Since the number of M-byte units can be indicated by a smaller number of bits along with increment of the k value, if the number of M-byte units can be indicated with 14 bits, the JC4 byte does not need to be used, and the MSB bit is allocated zero when the JC4 byte is no longer used. Allocating “1” to the MSB bit of the JC4 byte means that C15 through C21 are used for justification control. The JC3 byte stores a value indicating error presence/absence obtained by applying CRC-8 to detect whether any error occurs in JC1, JC2 or JC4. If TC bytes are used, the MSB bits of the TC bytes are allocated “1”, and the MSB bits of TC bytes that are not used are allocated “0”. The difference value information (CnD) may be represented with 14 bits using the TC1 and TC2 bytes, and the TC3 byte stores a value indicating error presence/absence obtained by applying CRC-7 to detect whether any error occurs in TC1 or TC2. In the current embodiment, the JC and TC bytes are used to control justification in mapping a client signal to an OPUk-Xpv frame, but it is also possible to apply JC and TC information for a plurality of OPUk-Xpv frames.

In the case of two or more virtual concatenated OPUk-Xv tributary slots, TC bytes may be located at a (15X+1)-th column and JC bytes may be located at a (15X+2)-th column. Meanwhile, if X=1 and only one OPUk-Xv tributary slot is virtually concatenated, no VCOH byte is needed and accordingly TC bytes can be positioned at VCOH bytes locations on the 15^{th} column. JC bytes are located at the 16^{th} column.

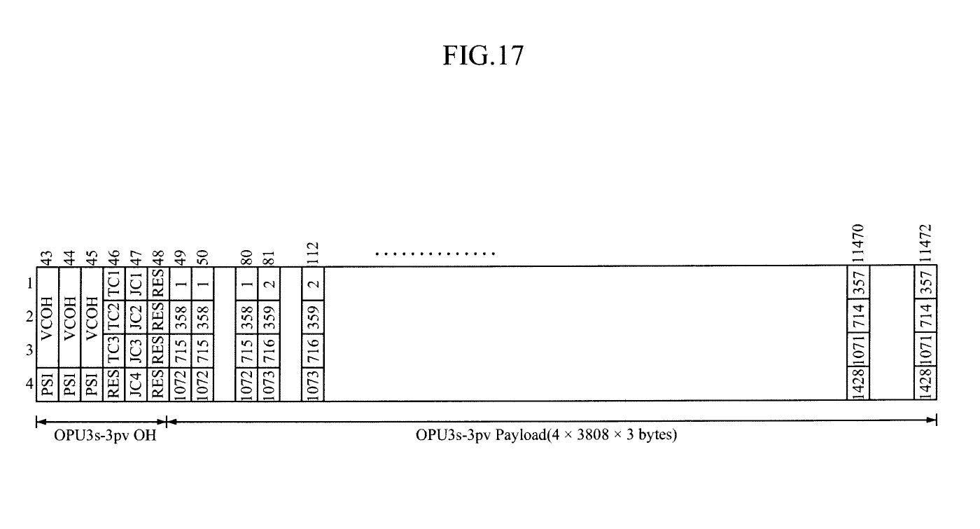

FIG. 17 shows an OPU3s-3pv frame structure using an OPU3s-3v tributary slot, which is a kind of an OPUk-Xpv frame structure using an OPUk-Xv tributary slot.

The OPU3s-3pv belongs to a level 3, M is 32 and the OPU3s-3v tributary slot can be segmented in units of 32 bytes. An OPU3s-3v tributary slot can be allocated 1428 32-byte units. For example, when the bit rate of the OPU3s-3pv is 110.505 Gbit/s 20 ppm and a 100GbE client signal is mapped to the OPU3s-3pv, the number of 32-byte units with which the client signal is mapped to the OPU3s-3pv will be sufficient to be 1427 or 1428. That is, the Cm byte has a value of 1427 or 1428.

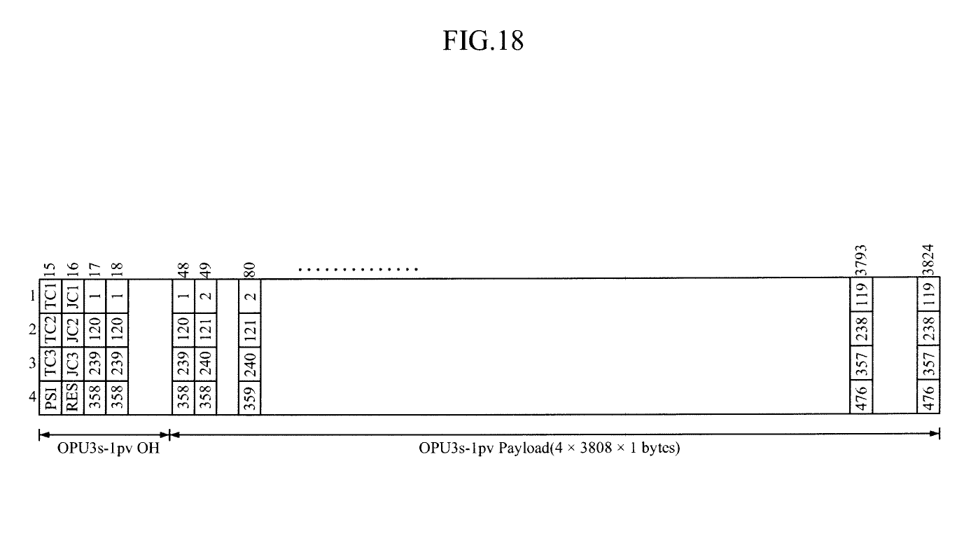

FIG. 18 shows an exemplary OPU3s-1pv frame structure using an OPUk-Xv tributary slot when X=1. The OPU3s-1pv belongs to a level 3, a M value is 32 and an OPU3s-1v tributary slot is segmented in units of 32 bytes. An OPU3s-1v tributary slot may contain 476 32-byte units. Since the virtual concatenation number (X) is 1, VCOH bytes are meaningless. Accordingly, TC bytes are positioned at VCOH bytes locations on the 15^{th} column and JC bytes are located on the 16^{th} column.

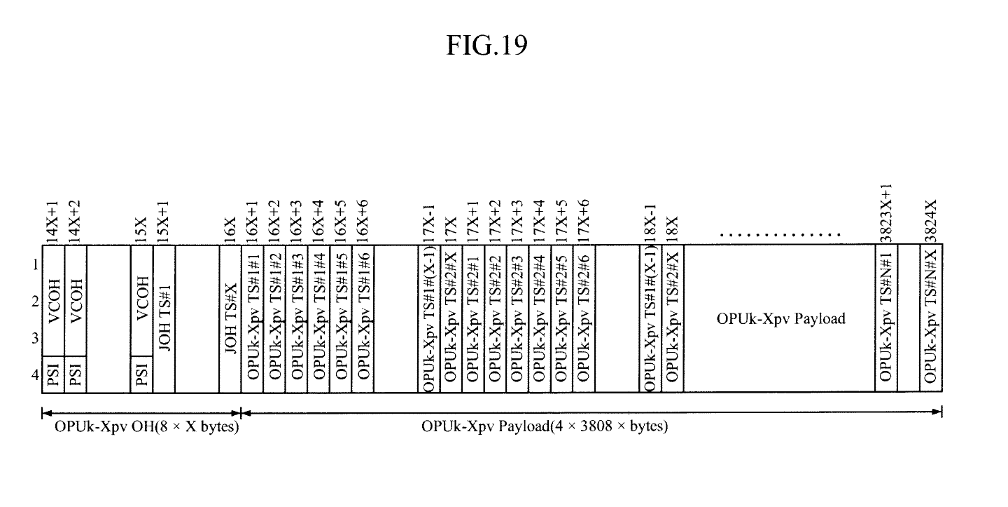

FIG. 19 shows an exemplary OPUk-Xpv frame structure using OPUk tributary slots.

Referring to FIG. 19, the OPUk-Xpv is composed of X OPUk tributary slots and each OPUk tributary slot is composed of N 1.25G tributary slots. In the current embodiment, each 1.25G tributary slot is denoted by TS#n-#m, wherein n and m are integers that satisfy 1≦n≦N and 1≦m≦X, respectively, #m represents a sequence number of the corresponding OPUk tributary slot and #n represents a sequence number of the corresponding 1.25G tributary slot in the m^{th} OPUk tributary slot. Accordingly, in the payload area of the OPUk-Xpv, a plurality of tributary slots are byte-interleaved and distinguished in the order of TS#1-#1, TS#1-#2, . . . , TS#1-#X, TS#2-#1, TS#2-#2, . . . , TS#N-#1, TS#N-#2, . . . , TS#N-#X. In the overhead area, PMSI may be included. Each 1.25G tributary slot is composed of several byte columns. The number of 1.25G tributary slots and the number of byte columns for 1.25 tributary slot are as follows.

TABLE 2

| | Total Number of 1.25 G TS | Total Number of Byte | |
|---|---|---|---|
| k value | for OPUk-Xv | Column for 1.25 G TS | |
| 1 | 2*X | 1904 | (=3808*X/(2*X)) |
| 2, 2e | 8*X | 476 | (=3808*X/(8*X)) |
| 3, 3e | 32*X | 119 | (=3808*X/(32*X)) |
| 4 | 80*X | 47.5 | (=3800*X/(2*X)) |

For example, in OPU2-10pv, TS#1-#1 belongs to a first OPU2 tributary slot of 10 OPU2 tributary slots and indicates a first 1.25G tributary slots of 8 1.25G tributary slots included in the to first OPU2 tributary slot. Likewise, TS#8-#2 indicates an 8^{th} 1.25G tributary slot in a second OPU2 tributary slot. A 1.25G tributary slot TS#n-#m of OPU2-10v is composed of 476 byte columns. That is, since OPU2-10pv including 38,080 byte columns is segmented into 10 OPUk tributary slots and each OPUk tributary slot is segmented into 8 1.25G tributary slots, each 1.25G tributary slot is composed of 476 byte columns. In the embodiment of FIG. 19, (14X+1)^{th} to 15^{th} columns may all have independent values and (15X+1)^{th} to 16^{th} columns are used as justification control overheads to map various client signals to the individual OPUk tributary slots.

A total number ts of 1.25G tributary slots to be used is decided depending on client signals to be mapped. A frame in which client signals are mapped to ts 1.25G tributary slots in an OPUk tributary slot is referred to as ODTUk-v.ts (pseudo-inversed Optical channel Data Tributary Unit k with ts 1.25G tributary slots).

For example, ODTU3-v.2 represents a mapping frame in which an OPU3 tributary slot is composed of 2 1.25G tributary slots. Such an ODTUk-v.ts frame is defined in unit of a multi-frame of OPUk-Xpv. If the number of byte columns of a 1.25G tributary slot is j, the number of rows of a multi-frame of OPUk-Xpv is r and a total number of used 1.25G tributary slots is ts, ODTUk-v.ts parameters according to a level k are as follows.

TABLE 3

| k | j | r | ts | ODTUk-v.ts | ODTUk-v.ts |
|---|---|---|---|---|---|
| Value | Value | Value | Value | Payload Bytes | Overhead Bytes |
| 1 | 1904 | 8 | 1 to 2 | 15232 x tx | 4 x ts |
| 2, 2e | 476 | 32 | 1 to 8 | 15232 x ts | 4 x ts |
| 3, 3e | 119 | 128 | 1 to 32 | 15232 x ts | 4 x ts |
| 4 | 95 | 160 | 1 to 80 | 15232 x ts | 4 x ts |

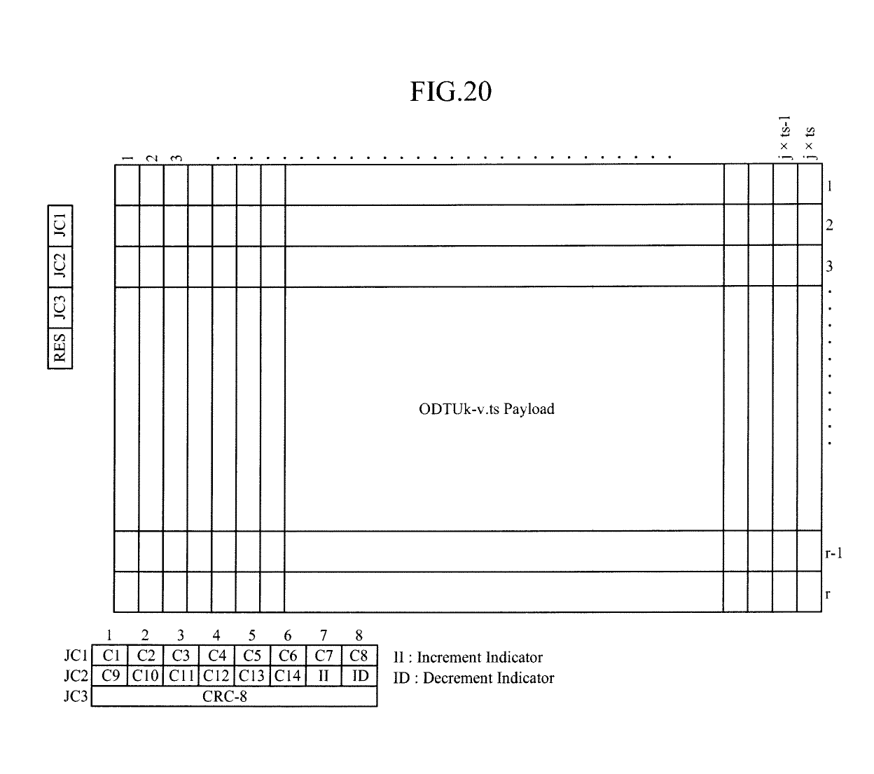

An exemplary ODTUk-v.ts frame is illustrated in FIG. 20. The ODTUk-v.ts payload includes j×ts byte columns according to the number ts of used 1.25G tributary slots and the ODTUk-v.ts frame has r byte columns according to a level k. Each ODTUk-v.ts payload includes 4×ts ODTUk-v.ts overhead bytes and 3 bytes of the 4×ts bytes are used to store JC information. Client signals are mapped in units of ts bytes to an ODTUk-v.ts frame according to the number ts of 1.25G tributary slots. The ODTUk-v.ts frame is allocated to ts 1.25G tributary slots in each OPUk tributary slot. Since the mapping is performed in units of ts bytes, a total number Cm of ts bytes is maximally 15232. The Cm value is included in the 3 JC bytes and sent. A bit indicating that the number of ts-byte units is incremented by 1 is an Increment Indicator (II) bit and a bit indicating that the number of ts-byte units is decremented by 1 is a Decrement Indicator (DI) bit. The JC3 byte stores a value indicating error presence/absence, obtained by applying CRC-8 to detect whether any error occurs in JC1 or JC2.

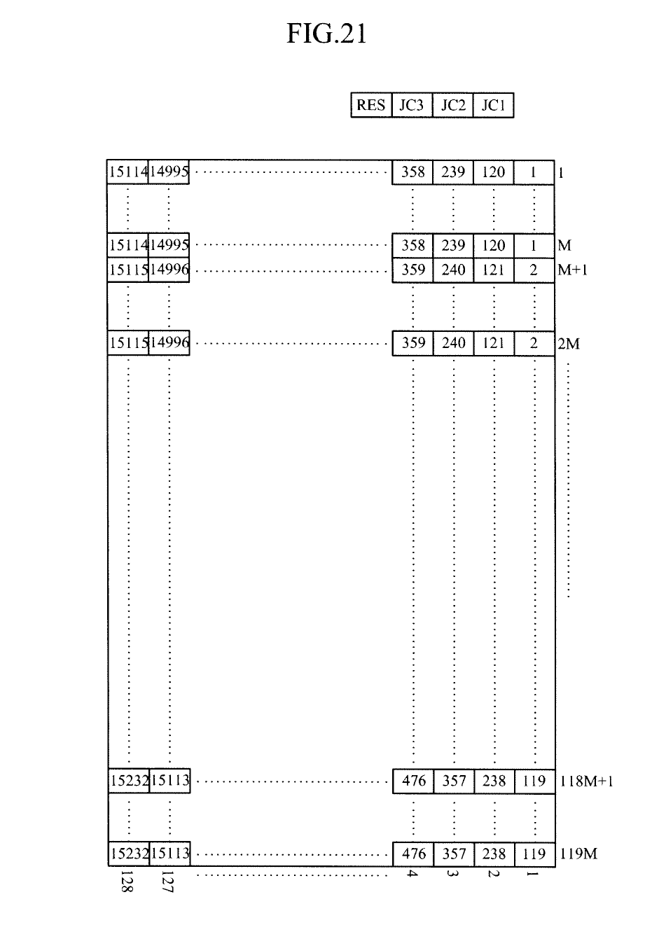

FIG. 21 shows an exemplary ODTU3-v.ts frame structure. The ODTU3-v.ts is mapped to ts 1.25G tributary slots. The ODTU3-v.ts payload is composed of 119×ts byte columns and 128 byte rows. An ODTUk-v.ts payload includes 4×ts ODTUk-v.ts overhead bytes, and 3 bytes of the 4×ts bytes are used to store JC information. An ODTU3-v.ts frame that is mapped to OPUk tributary slots may be allocated maximally 32 1.25G tributary slots. Since client signals are mapped to an ODTU3-v.ts frame in units of ts bytes according to the number ts of 1.25 tributary slots used to map the client signals, the ODTU3-v.ts is segmented into totally 15232 ts bytes.

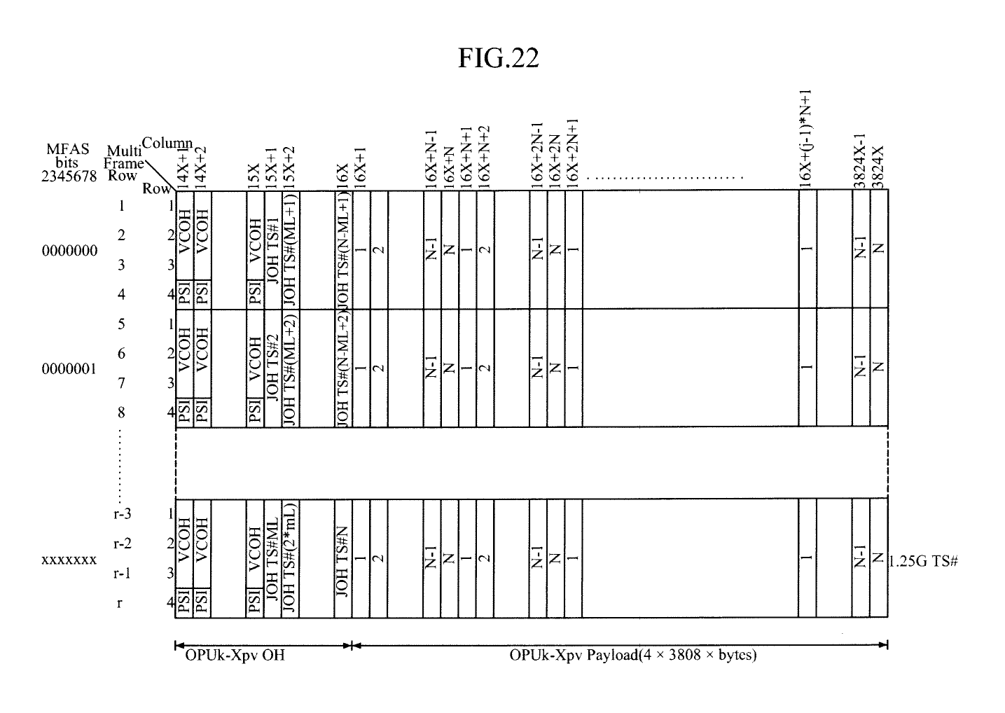

FIGS. 22 through 27 show OPUk-Xpv frames using 1.25G tributary slots, according to exemplary embodiments.

Referring to FIG. 22, OPUk-Xpv is composed of N 1.25G tributary slots. In FIG. 22, each 1.25G tributary slot is denoted by TS#n (for convenience of description, will be simply denoted by n), wherein n is an integer that satisfies 1≦n≦N. That is, n represents a sequence number of a 1.25G tributary slot. Accordingly, in the payload area of the OPUk-Xpv, N tributary slots are byte-interleaved and distinguished in the order of 1, 2, . . . , N. In the overhead areas, there may be VCOH, PSI, JC, etc. Particularly, N pieces of JC information for N 1.25G tributary slots are located at the (15X+1)^{th} to 16X^{th} columns in units of ML multi-frames. Accordingly, N=ML*X. If a row length of a multi-frame is r, r=4*mL since OPUk-Xpv (k=1, 2, 2e, 3, 3e, . . . ) is composed of 4 rows.

The multi-frame length ML, the row length r of a multi-frame and the number N of 1.25G tributary slots according to a value k are as follows.

TABLE 4

| | | | N Value (Total | j Value (Total | |
|---|---|---|---|---|---|
| k | ML | r | Number of 1.25 G TSs | Number of Byte columns | |
| Value | Value | Value | for Each OPUk-Xpv) | for 1.25 G TS | |
| 1 | 2 | 8 | 2*X | 1904 | (=3808*X/2*X) |
| 2, 2e | 8 | 32 | 8*X | 476 | (=3808*X/8*X) |
| 3, 3e | 32 | 128 | 32*X | 119 | (=3808*X/32*X) |
| 4 | 80 | 160 | 80*X | 47.5 | (=3800*X/80*X) |

For example, OPU3e-3pv includes totally 96 1.25G tributary slots, and TS#1 indicates a first 1.25G tributary slot of the 96 1.25G tributary slots. Likewise, TS#80 represents an 80^{th} 1.25G tributary slot. Each 1.25G tributary slot of OPU3e-3pv is composed of 119 columns and 128 rows. Also, a justification overhead (JOH) corresponding to a 1.25G tributary slot appears repeatedly in units of 32 multi-frames.

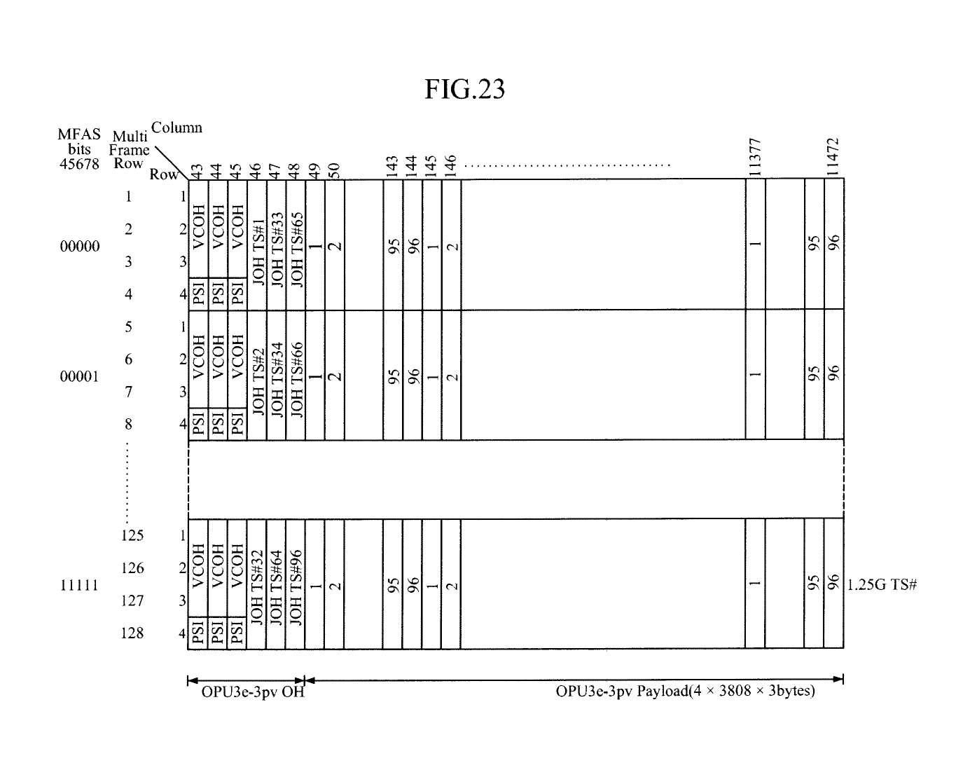

FIG. 23 shows an exemplary OPU3e-3pv frame structure using 1.25G tributary slots. The OPU3e-3pv belongs to a level 3e and includes totally 96 (=32×3) 1.25G tributary slots. TS#1 represents a first 1.25G tributary slot of the 96 (=32×3) 1.25G tributary slots. Likewise, TS#80 represents an 80^{th} 1.25G tributary slot. Each 1.25G tributary slots of OPU3e-3pv is composed of 119 columns and 128 rows. Also, maximally 96 JOHs each corresponding to a 1.25G tributary slot are repeated in units of 32 multi-frames.

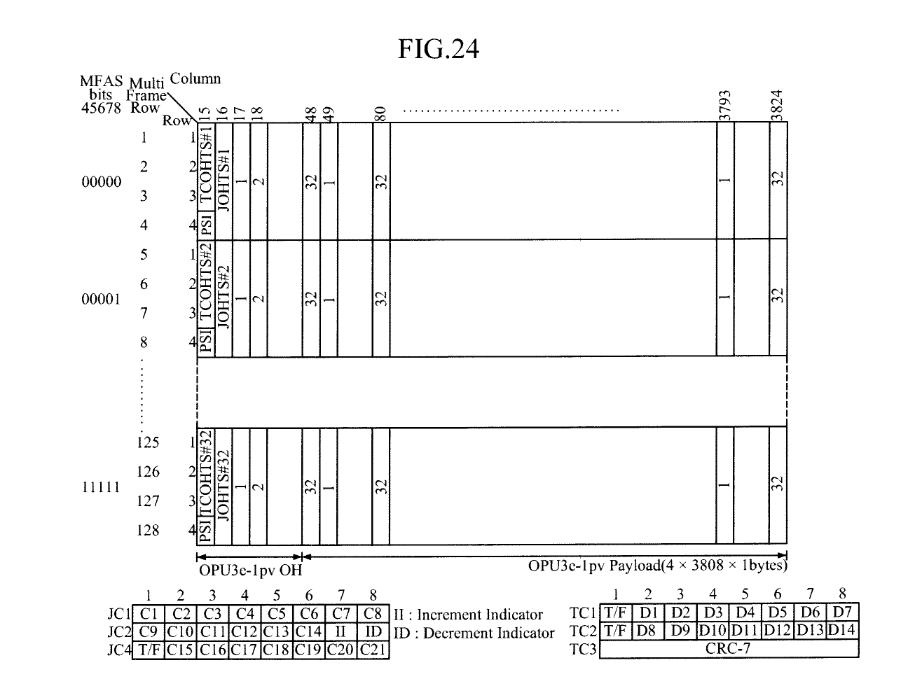

FIG. 24 shows an exemplary OPU3e-1pv frame structure using 1.25G tributary slots when X=1. OPU3e-1pv belongs to a level 3e and includes 32 1.25G tributary slots, and an OPU3e-1pv multi-frame is composed of 32 frames. On the 16^{th} column of OPU3e-1pv, maximally 32 justification overheads (JOH) appear repeatedly in units of multi-frames. Since only one OPU3e-1pv frame is virtual-concatenated, VCOH bytes are meaningless and TC overhead bytes are located at VCOH byte locations on the 15^{th} column. Also, in order to compensate for the total number Cm of is bytes and a total number Cn of bits to have to be substantially sent to map client signals, a difference CnD between the Cn and Cm values is included in TC information and sent. The difference value information (CnD) may be represented with 14 bits using the TC1 and TC2 bytes, and the TC3 byte stores a value indicating error presence/absence, obtained by applying CRC-7 to detect whether any error occurs in TC1 or TC2.

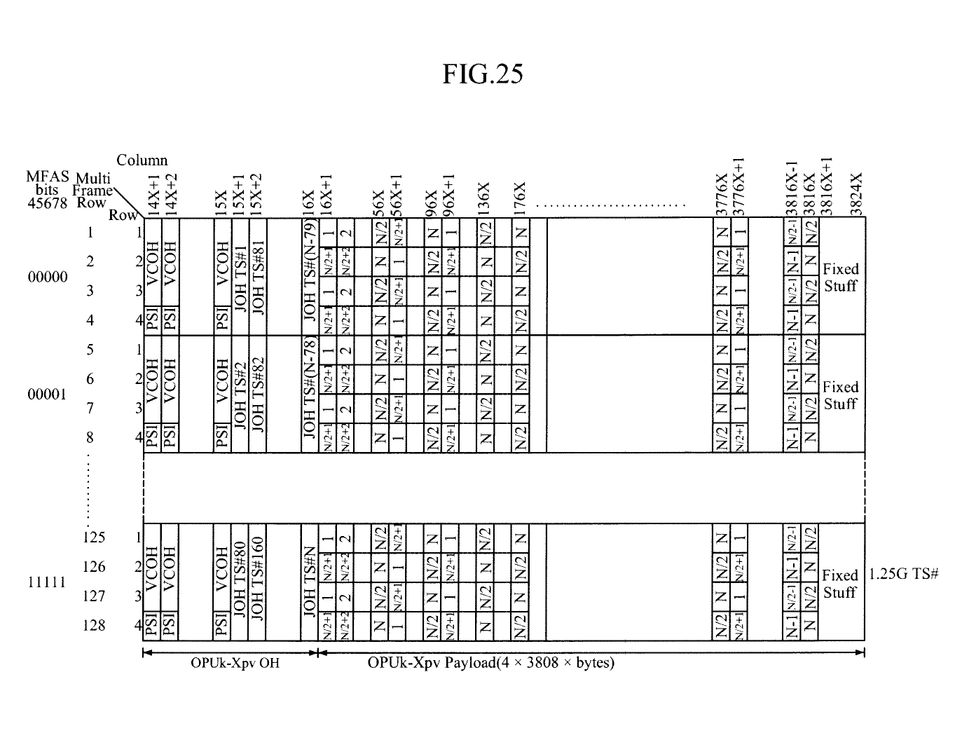

If k=4, since 3808*X is not a multiple of the total number N of 1.25G tributary slots, that is, it is not a multiple of 80*X, 8*X fixed stuff byte columns are located at a part of the payload area, thus making the length of the entire columns of the payload area be 3800*X, excluding the to fixed stuff byte columns. At this time, since the j value is 47.5, it is impossible to equally distribute the 80*X 1.25G tributary slots with only one row, and accordingly the 80*X 1.25G tributary slots are equally distributed over two rows. As such, in order to segment an OPU4-Xpv payload area into 1.25G tributary slots, at least two rows are needed. Accordingly, in an OPU4-Xpv multi-frame, r=2*mL. As illustrated in FIG. 25, an OPU4-Xpv frame is segmented into N (=80*X) 1.25G tributary slots.

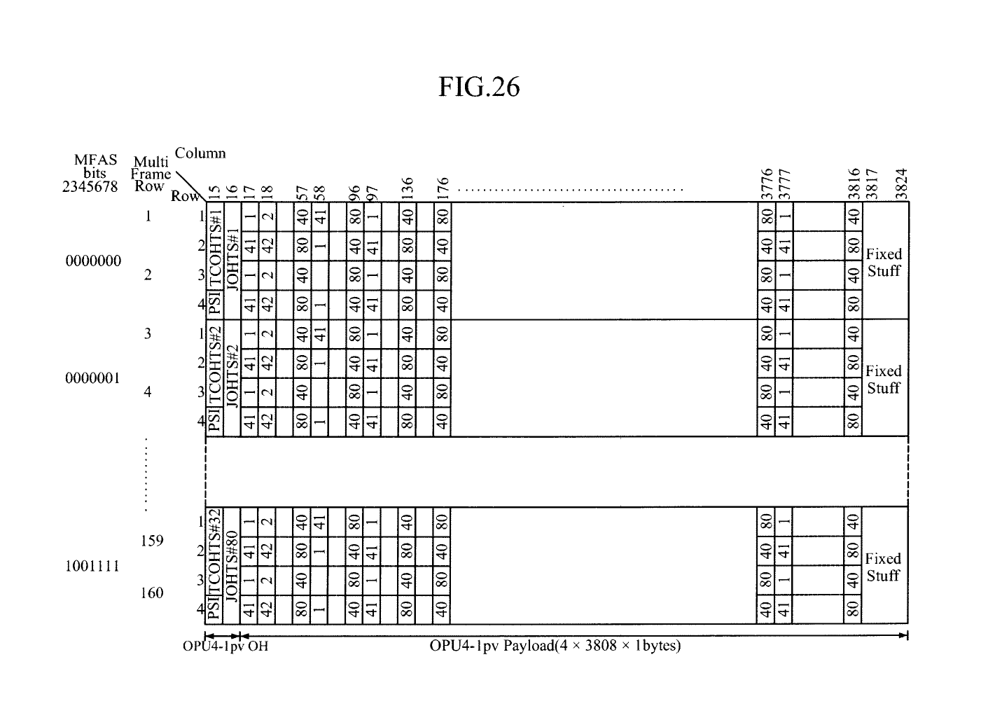

FIG. 26 shows an exemplary OPU4-1pv frame structure using 1.25G tributary slots when X=1. OPU4-1pv belongs to a level 4 and includes totally 80 1.25G tributary slots, and an OPU4-1pv multi-frame is composed of 80 frames. On the 16^{th} column, maximally 80 JOHs appear repeatedly in units of multi-frames. If X=1, the OPU4-1pv frame can operate with only JC1, JC2 and JC3 bytes without using the JC4 byte. Since the virtual concatenation number (X) is 1, the VCOH bytes are meaningless, and accordingly, like the embodiment of FIG. 24, TC overhead bytes may be located at the VCOH byte locations on the 15^{th} column.

Thus, 8 fixed stuff byte columns are located at a part of the payload area to make the length of the entire columns of the payload area be 3800. Consequently, the 80 1.25G tributary slots are equally distributed over two rows.

As seen in FIG. 22, since maximally N independent client signals can be mapped using 1.25G tributary slots, the number of JOHs including JC information have to be maximally N. Accordingly, JOH bytes are distributed to the (15X+1)^{th} to 16X^{th} columns in units of ML multi-frames so that N (=ML*X) JOHs are equally distributed over the OPUk-Xv. An ODTUk-v.ts frame is created depending on how many 1.25G tributary slots are used to map client signals, and the ODTUk-v.ts frame is allocated ts tributary slots of N 1.25G tributary slots allocated to an OPUk-Xpv frame, so that the ODTUk-v.ts is mapped to the OPUk-Xpv.

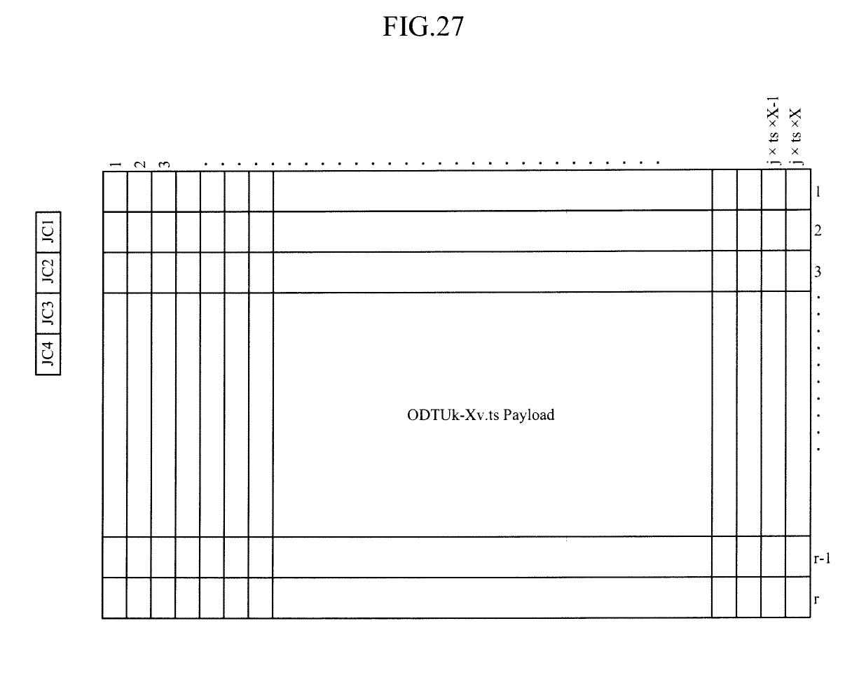

Such a mapping frame, which is composed of ts 1.25G tributary slots to map client signals, is referred to as ODTUk-v.ts. For example, ODTU3-v.2 represents a mapping frame to which is composed of 2 1.25G tributary slots in an OPUk-Xpv frame. The ODTUk-v.ts frame is defined in units of multi-frames of OPUk-Xpv, and an exemplary ODTUk-v.ts frame is illustrated in FIG. 27. A difference between the ODTUk-v.ts frame of FIG. 27 and the ODTUk-v.ts frame of FIG. 20 is in that the ODTUk-v.ts frame of FIG. 27 may include a JC4 byte additionally in the overhead of the ODTUk-v.ts. If the number of byte columns of a 1.25G tributary slot is j, the number of rows of a multi-frame of OPUk-Xpv is r and a total number of used 1.25G tributary slots is ts, ODTUk-v.ts parameters according to a level k can be expressed by the following Table 5.

TABLE 5

| k | J | r | ts | ODTUk-v.ts | ODTUk-v.ts |
|---|---|---|---|---|---|
| Value | Value | Value | Value | Payload Bytes | Overhead Bytes |
| 1 | 1904 | 8 | 1 to 2*X | 15232*ts*X | 4 x ts |
| 2, 2e | 476 | 32 | 1 to 8*X | 15232*ts*X | 4 x ts |
| 3, 3e | 119 | 128 | 1 to 32*X | 15232*ts*X | 4 x ts |
| 4 | 95 | 160 | 1 to 80*X | 15200*ts*X | 4 x ts |

In the ODTUk-v.ts payload, there are j×ts byte columns according to the number ts of used 1.25G tributary slots and the ODTUk-v.ts frame has r bytes columns according to the k level. Each ODTUk-v.ts payload include 4×ts ODTUk-v.ts overhead bytes, and 4 bytes of the 4×ts overhead bytes are used to store JC information. As seen in Table 5, the number of ODTUk-v.ts payload bytes is 15232*ts*X, and a Cm value reaches maximally 15232*X when client signals are mapped in units of ts bytes. Since the maximum value of X is 256, the Cm value can be indicated with maximally 21 bits, and the JC4 byte is used additionally when X is greater than 2. A bit indicating that the number of ts byte units is incremented by 1 is an Increment Indicator (II) bit and a bit indicating that the number of ts byte units is decremented by 1 is a Decrement Indicator (DI) bit. Allocating “1” to the MSB bit of the JC4 byte means that C15 through C21 are used for justification control. The JC3 byte stores a value indicating error presence/absence, obtained by applying CRC-8 to detect whether any error occurs in JC1, JC2 or JC4.

ODTU3-v.ts is mapped to ts 1.25 tributary slots. The ODTU3-v.ts payload is composed of 119×ts byte columns and 128 byte rows. An ODTUk-v.ts payload includes 4×ts ODTUk-v.ts overhead bytes and 3 bytes of the 4×ts bytes are used to store JC information. An ODTU3-v.ts frame to be mapped to OPUk tributary slots may be allocated maximally 32 1.25G tributary slots. Since client signals are mapped in units of ts bytes to an ODTU3-v.ts frame according to the number ts of 1.25G tributary slots to map the client signals, the ODTU3-v.ts frame is segmented into totally 15232 ts bytes.

Now, an overhead area that is corrected for pseudo-inverse multiplexing, according to an exemplary embodiment, will be described.

First, PT bytes can be defined as follows.

TABLE 6

| MSB | LSB | Hex | |
|---|---|---|---|
| 1 2 3 4 | 5 6 7 8 | code | Interpretation |
| 0 0 0 0 | 0 0 0 1 | 01 | Experimental mapping |
| 0 0 0 0 | 0 0 1 0 | 02 | Asynchronous CBR mapping |
| 0 0 0 0 | 0 0 1 1 | 03 | Bit synchronous CBR mapping |
| 0 0 0 0 | 0 1 0 0 | 04 | ATM mapping |
| 0 0 0 0 | 0 1 0 1 | 05 | GFP mapping |
| 0 0 0 0 | 0 1 1 0 | 06 | Virtual Concatenated signal (OPUk-Xv) |
| 0 0 0 1 | 0 0 0 0 | 10 | Bit stream with octet timing mapping |
| 0 0 0 1 | 0 0 0 1 | 11 | Bit stream without octet timing mapping |
| 0 0 1 0 | 0 0 0 0 | 20 | ODU multiplex structure |
| 0 0 1 1 | 0 0 0 0 | 30 | Pseudo-Inverse Multiplexed signal |
| | | | (OPUk-Xpv) supporting an OPUk-Xv |
| | | | tributary slot |
| 0 0 1 1 | 0 0 0 1 | 31 | Pseudo-Inverse Multiplexed signal |
| | | | (OPUk-Xpv) supporting OPUk |
| | | | tributary slots |
| 0 0 1 1 | 0 0 1 0 | 32 | Pseudo-Inverse Multiplexed signal |
| | | | (OPUk-Xpv) supporting 1.25 G |
| | | | tributary slots |
| 0 1 0 1 | 0 1 0 1 | 55 | Not available |
| 0 1 1 0 | 0 1 1 0 | 66 | Not available |
| 1 0 0 0 | x x x x | 80-8F | Reserved codes for proprietary use |
| 1 1 1 1 | 1 1 0 1 | FD | NULL test signal mapping |
| 1 1 1 1 | 1 1 1 0 | FE | PRBS test signal mapping |
| 1 1 1 1 | 1 1 1 1 | FF | Not available |

The PT bytes are used to indicate that a signal received by a receiving terminal is one received through pseudo-inverse multiplexing according to the current embodiment. As described above, the pseudo-inverse multiplexing is mainly classified according to three types of tributary slots: OPUk-Xv tributary slot, OPUk tributary slot and 1.25G tributary slot. If a PT byte value is 0x30, this means that the corresponding signal has been subjected to pseudo-inverse multiplexing using an OPUk-Xpv tributary slot. If a PT byte value is 0x31, this means that the corresponding signal has been subjected to pseudo-inverse multiplexing using X OPUk tributary slots. Also, if a PT byte value is 0x32, this means that the corresponding signal has been subjected to pseudo-inverse multiplexing using a plurality of 1.25G tributary slots. For compatibility with OPUk-Xv, a VcPT (Virtual concatenation Payload Type) byte can be used to identify which type of tributary slots are used after setting a PT byte value to 0x30.

The VcPT byte can be defined as follows.

TABLE 7

| MSB | LSB | Hex | |
|---|---|---|---|
| 1 2 3 4 | 5 6 7 8 | code | Interpretation |
| 0 0 0 0 | 0 0 0 1 | 1 | Experimental mapping |
| 0 0 0 0 | 0 0 1 0 | 2 | Asynchronous CBR mapping |
| 0 0 0 0 | 0 0 1 1 | 3 | Bit synchronous CBR mapping |
| 0 0 0 0 | 0 1 0 0 | 4 | ATM mapping |
| 0 0 0 0 | 0 1 0 1 | 5 | GFP mapping |
| 0 0 0 0 | 0 1 1 0 | 6 | Asynchronous Generic CBR mapping (GMP) |
| 0 0 0 1 | 0 0 0 0 | 10 | Bit stream with octet timing mapping |
| 0 0 0 1 | 0 0 0 1 | 11 | Bit stream without octet timing mapping |
| 0 0 1 0 | 0 0 0 1 | 21 | OPU multiplex structure supporting 1.25 G |
| | | | tributary slots |
| 0 1 0 1 | 0 1 0 1 | 55 | Not available |
| 0 1 1 0 | 0 1 1 0 | 66 | Not available |
| 1 0 0 0 | x x x x | 80-8F | Reserved codes for proprietary use |
| 1 1 1 1 | 1 1 0 1 | FD | NULL test signal mapping |
| 1 1 1 1 | 1 1 1 0 | FE | PRBS test signal mapping |
| 1 1 1 1 | 1 1 1 1 | FF | Not available |

A difference between the VcPT byte of OPUk-Xpv using X OPUk tributary slots and the VcPT byte of existing OPUk-Xv is in that all X VcPT bytes located at (14+1)^{th} to 15X^{th} columns on the 4^{th} row of OPUk-Xv have the same value, whereas X VcPT bytes located at (14+1)^{th} to 15X^{th} columns on the 4^{th} row of OPUk-Xpv may have independent values. That is, the X VcPT bytes define the respective virtual concatenation payload types of X OPUk tributary slots. Accordingly, in the case of the OPUk-Xpv method, the first VcPT byte located at the (14+1)^{th} column on the 4^{th} row is 0x02, this means that asynchronous CBR mapping is performed on the first OPUk tributary slot, and if the final VcPT byte located at the 15X^{th} column on the 4^{th} row is to 0x05, this means that Generic Frame Procedure (GFP) mapping is performed on the final X^{th} OPUk tributary slot.

As such, an OPUk-Xpv signal, which is composed of a plurality of OPUk tributary signals, can map client signals using OPUk tributary signals, independently, and also segment each OPUk tributary slot into 1.25G tributary slots and then map and multiplex client signals with smaller capacities using the 1.25G tributary slots.

Since OPUk-Xpv using an OPUk-Xv tributary slot can map only a client signal, the VcPT byte of OPUk-Xpv can store all values excluding “21”. Whereas, in the case of an OPUk-Xpv signal which is composed of 1.25G tributary slots, the PT byte value is 32 and the VcPT byte value is 21.

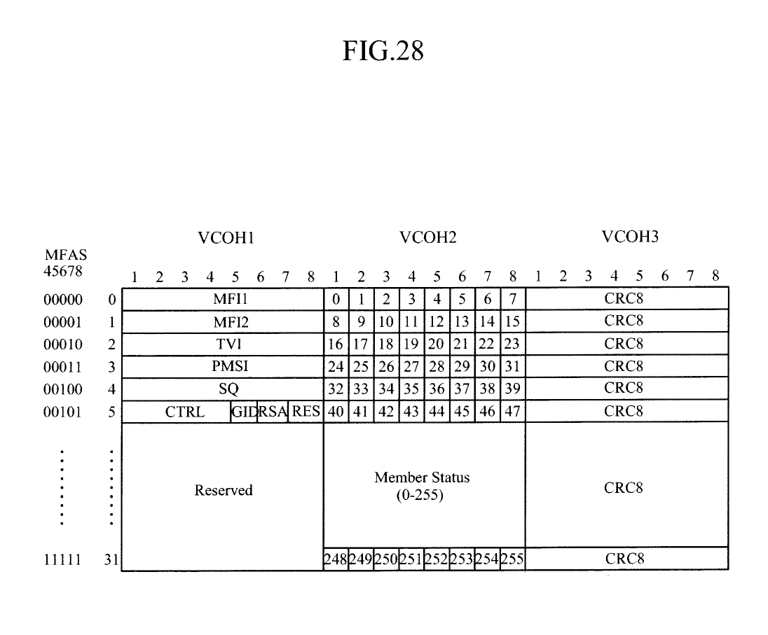

FIG. 28 shows an exemplary overhead structure of OPUk-Xpv using OPUk tributary slots.

In FIG. 28, a Total Virtual Concatenated signal Indicator (TVI) provides information indicating a total number of virtual concatenated signals. That is, the TVI corresponds to a “X” value of OPUk-Xpv. The TVI byte is used to allow a receiving terminal to recognize how many OPUk signals can be virtually concatenated by inverse multiplexing. However, the TVI byte is not essential. The reason is because a total number of virtual concatenated signals can be obtained by analyzing SQ bytes of all OPUk signals to find out a virtual maximum value of the SQ byte values and then adding “1” to the maximum SQ byte value.

The total number of virtual concatenated signals subjected to pseudo-inverse multiplexing provides information indicating a total number of PMSI bytes to have to be considered, which allows the receiving terminal to easily perform hardware control on PMSI decoding. However, the information about the total number of virtual concatenated signals and the total number of PMSI bytes is only useful information, not essential. Particularly, in a structure of using the “X” value of OPUk-Xpv as a fixed value, finding the total number of virtual concatenated signals is no longer needed since the “X” value has been already known.

A PMSI byte, which is the 4^{th} byte among the reserved bytes of VCOH1, provides information regarding a Pseudo-inverse Multiplex Structure Identifier (PMSI). Since PMSI bytes are provided for OPUk tributary slots, respectively, the PMSI bytes provide information about how various client signals are pseudo-inverse multiplexed to the respective OPUk tributary slots.

For example, if a tributary port value of a PMSI byte in the first OPUk tributary slot of OPUk-Xpv is identical to a tributary port value of a PMSI byte in the second OPUk tributary slot, the two OPUk tributary slots are virtually concatenated tributary slots. If the tributary port values are different from each other, this means that the respective tributary slots map client signals, independently.

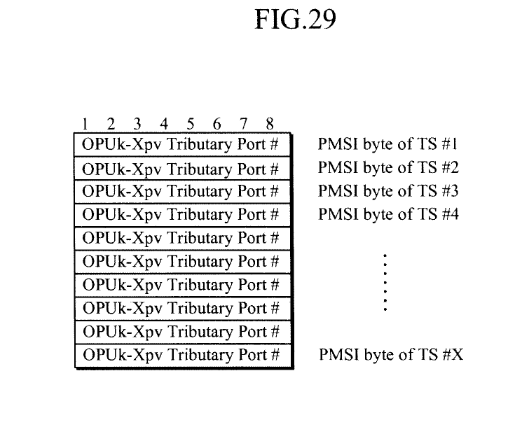

FIG. 29 shows a Pseudo Multiplex Structure Identifier (PMSI) structure of OPUk-Xpv using OPUk tributary slots according to an exemplary embodiment.

In FIG. 29, OPUk-Xpv includes X PMSI areas and the X PMSI areas are arranged in a sequence order designated by a SQ value. A SQ value of the m^{th} OPUk tributary slot is m−1. In the current embodiment, OPUk-Xpv includes X OPUk tributary slots and also each OPUk tributary slot may be segmented into a predetermined number of 1.25G tributary slots. Accordingly, the SQ value of the m^{th} OPUk tributary slot of the X OPUk tributary slots is m−1, and the OPUk tributary slot is denoted by TS-#m. Also, the n^{th} 1.25G tributary slot in the m^{th} OPUk tributary slot is denoted by TS#n-#m. For example, an OPUk tributary slot whose SQ byte is 0 is denoted by TS-#1. Likewise, an OPUk tributary slot whose SQ byte is 1 is denoted by TS-#2. Also, the second 1.25G tributary slot in an OPUk tributary slot whose SQ byte value is 2 is denoted by TS#2-#3.

Since the “X” value of OPUk-Xpv is defined to express maximally upto 256, the tributary port of a PMSI area also has to express maximally upto 256 and accordingly, 8 bits have to all be used to express tributary port information of OPUk-Xpv.

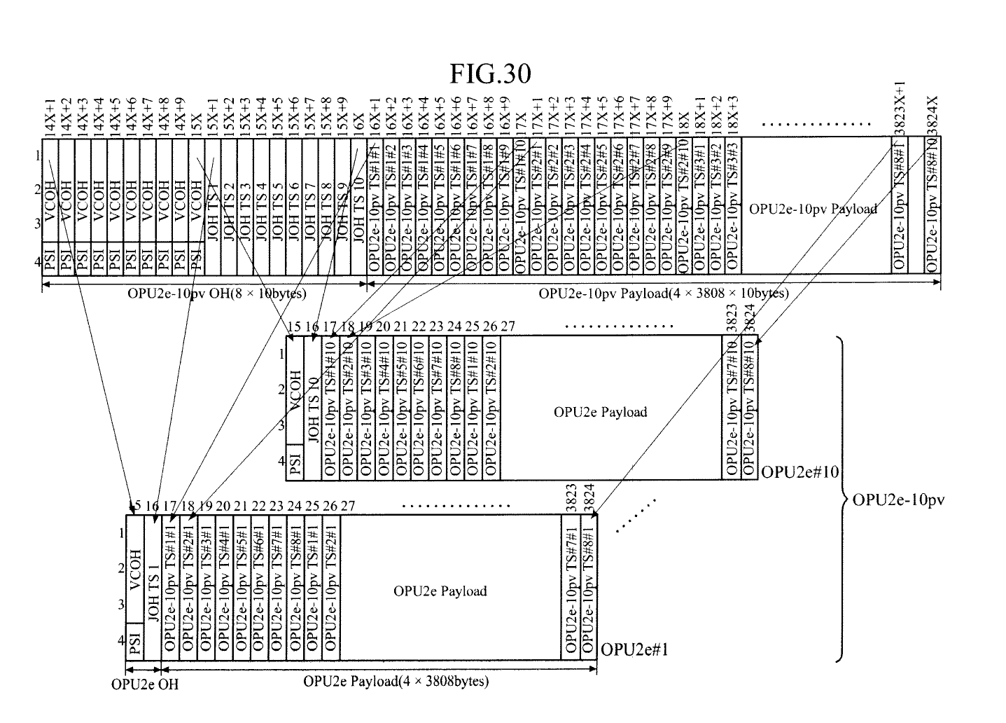

FIG. 30 shows an OPU2e-10pv frame using OPU2e tributary slots according to an exemplary embodiment.

Referring to FIG. 30, in the case of OPU2e-10pv, X=10 and each OPU2e tributary slot may be composed of 8 1.25G tributary slots.

The overhead of OPU2e-10pv is totally 4×2×10 bytes and the payload is 4×3808×10 bytes. Also, the OPU2e-10pv includes 10 OPU2e tributary slots and each OPU2e tributary slot is segmented into 8 1.25G tributary slots. In addition, the n^{th} 1.25G tributary slot of the m^{th} OPU2e tributary slot in OPU2e-10pv is denoted by TS#n-#m.

If a 100GbE signal is mapped to OPU2e-10pv, the 100GbE signal is mapped to 10 OPU2e tributary slots, sequentially. A 40GbE signal is mapped to 4 OPU2e tributary slots, sequentially. Accordingly, 4×8 1.25G tributary slots included in the 4 OPU2e tributary slots are all used to map the 40GbE signal. A 10GbE signal is mapped to an OPU2e tributary slot. Likewise, a 1GbE signal is mapped to a 1.25G tributary slot and accordingly, mapped to a corresponding one of 8 1.25G tributary slots in an OPU2e tributary slot.

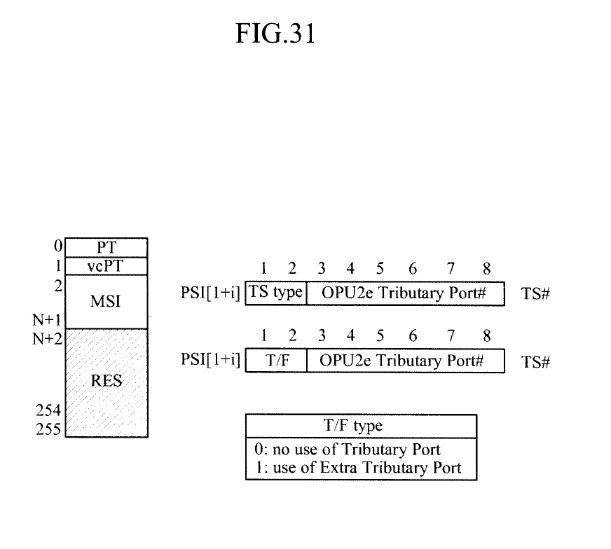

FIG. 31 shows a MSI byte of exemplary OPUk-Xpv using OPUk tributary slots, wherein k=2e and X=10.

Referring to FIG. 31, the PMSI bytes of OPUk-Xpv are used to inform how the OPU2e tributary slots illustrated in FIG. 30 is inverse-multiplexed, and the MSI bytes of OPU2e-Xpv using OPU2e tributary slots are used to inform how the 1.25G tributary slots in each OPU2e tributary slot are inverse-multiplexed.

The MSI bytes of OPUk-Xpv using OPU2e tributary slots are N bytes of the reserved bytes of PSI bytes, wherein N is the number of 1.25G tributary slots included in an OPU2e tributary slot. That is, an OPUk tributary slot, such as an OPU2 tributary slot or an OPU2e tributary slot, composed of 8 1.25G tributary slots, uses the 2^{nd} to 9^{th} rows as MSI bytes. An OPUk tributary slot composed of 16 1.25G tributary slots uses the 2^{nd} to 17^{th} rows as MSI bytes. Since an OPU2e tributary slot is composed of 8 1.25G tributary slots, 8 bytes from the 2^{nd} to 9^{th} rows of PSI bytes are used as the MSI bytes of OPUk-Xpv using OPU2e tributary slots. The first upper bit on each MSI row byte indicates whether the corresponding 1.25 tributary slot is used to map a client signal. If the upper bit T/F is set to “0”, this indicates that the corresponding 1.25G tributary slot is not used to map a client signal. On the contrary, if the upper bit T/F is set to “1”, this indicates that the corresponding 1.25G tributary slot is used to map a client signal.

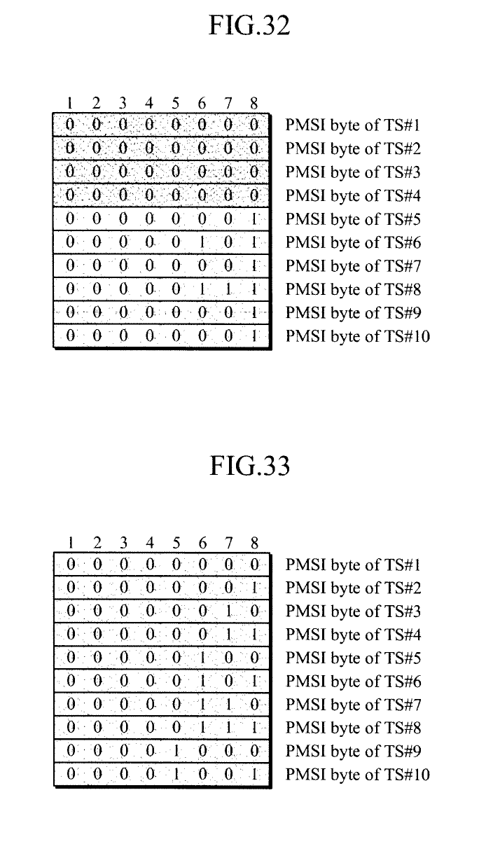

FIGS. 32 through 37 show examples of PMSI coding of OPUk-Xpv using OPUk tributary slots.

For example, it is assumed that two 10GbE signals and two 40GbE signals are pseudo-inverse multiplexed to OPU2e-10pv.

Since an OPU2e tributary signal can map a client signal having a bit rate of 10.3125 Gbit/s, a 10GbE signal may be mapped using an OPU2e tributary slot and a 40GbE signal may be mapped using 4 OPU2e tributary slots. At this time, a 10GbE signal is mapped to an OPU2e tributary slot TS-#6, the other 10GbE signal is mapped to an OPU2e tributary slot TS-#8, a 40GbE signal is mapped to OPU2e tributary slots TS-#1, TS-#2, TS-#3 and TS-#4 and the other 40GbE signal is mapped to OPU2e tributary slots TS-#5, TS-#7, TS-#9 and TS-#10.

In this case, PMSI coding is illustrated in FIG. 32. Tributary port values of PMSI bytes corresponding to the 1^{st} to 4^{th} OPU2e tributary slots are the same as 0x00, and this indicates that OPU2e tributary slots TS-#1, TS-#2, TS-#3 and TS-#4 are virtually concatenated to each other, wherein a total capacity of the OPU2e tributary slots TS-#1, TS-#2, TS-#3 and TS-#4 reaches 40G. Likewise, tributary port values of PMSI bytes corresponding to the 5^{th}, 7^{th}, 9^{th} and 10^{th} OPU2e tributary slots TS-#5, TS-#7, TS-#9 and TS-#10 are the same as 0x01, and this indicates that the OPU2e tributary slots TS-#5, TS-#7, TS-#9 and TS-#10 are also virtually concatenated to each other and also a total capacity thereof reaches 40G. In order to map a 50G client signal, PMSI bytes corresponding to 5 OPU2e tributary slots have to be allocated the same tributary port value.

FIG. 33 shows an example where 10 10GbE signals are pseudo-inverse multiplexed to OPU2E-10v using OPU2e tributary slots. In this case, 10GbE signals are mapped to the OPU2e tributary slots, respectively, and accordingly it is only needed to differentiate tributary port values of PMSI bytes.

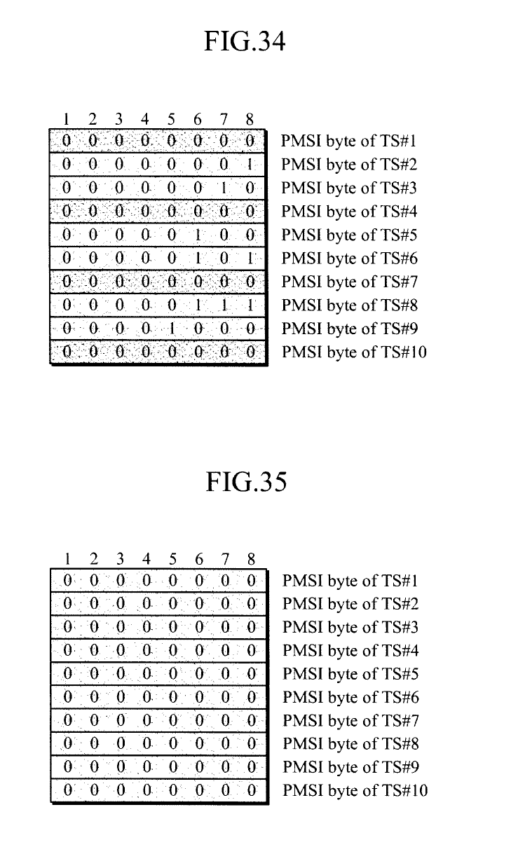

FIG. 34 shows an example where pseudo-inverse multiplexing is performed on 6 10GbE signals and one 40GbE signal. In this case, the 40GbE signal is mapped to 4 OPU2e tributary slots TS-#1, TS-#4, TS-#7 and TS-#10, and for this, it is needed to allocate the same value as tributary port values of PMSI bytes of the tributary slots TS-#1, TS-#4, TS-#7 and TS-#10. In order to map the remaining 6 10GbE signals, different tributary port values are allocated to the PMSI bytes of the 6 OPU2e tributary slots. Accordingly, a receiving terminal can recognize from the PMSI bytes that the 1^{st}, 4^{th}, 7^{th} and 10^{th} OPU2e tributary slots are virtually concatenated to each other and the remaining 6 OPU2e tributary slots map client signals independently without being virtually concatenated.

FIG. 35 shows an example where 100GbE signals are pseudo-inverse multiplexed to OPU2e-10pv using OPU2e tributary slots. In this case, since 10 OPU2e tributary slots have to be virtually concatenated, tributary port values of PMSI bytes of the 10 OPU2e tributary slots are allocated the same value.

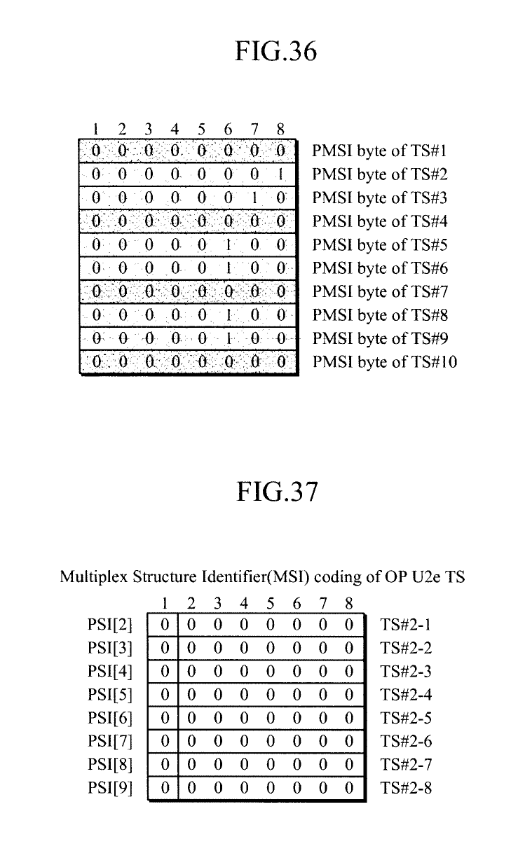

FIG. 36 shows an example where 16 1GbE signals and 2 40GbE signals are pseudo-inverse multiplexed to OPU2e-10pv using OPU2e tributary slots. In order to map a 40GbE signal, 4 OPU2e tributary slots are used, and accordingly it is only needed to allocate the same value as tributary port values of PMSI bytes of tributary slots TS-#5, TS-#6, TS-#8 and TS-#9. Different tributary port values are allocated to PMSI bytes of the remaining tributary slots TS-#2 and TS-#3 so that the second and third OPU2e tributary slots operate independently. In order to multiplex 1GbE signals into the second and third OPU2e tributary slots, MSI bytes of OPU2e-10pv using OPU2e tributary slots are used. The 1GbE signals are independently mapped to 8 1.25G tributary slots included in each of the second and third OPU2e tributary slots, which follows coding of MSI bytes shown in FIG. 37.

FIG. 37 shows exemplary MSI coding that is performed on the second OPU2e tributary slot. That is, 8 MSI bytes are allocated different 1.25G tributary port values, indicating that the 8 1.25G tributary slots map client signals independently. The first upper bit of each of the 8 MSI bytes is allocated “1” to indicate that 1.25G tributary slots are utilized.

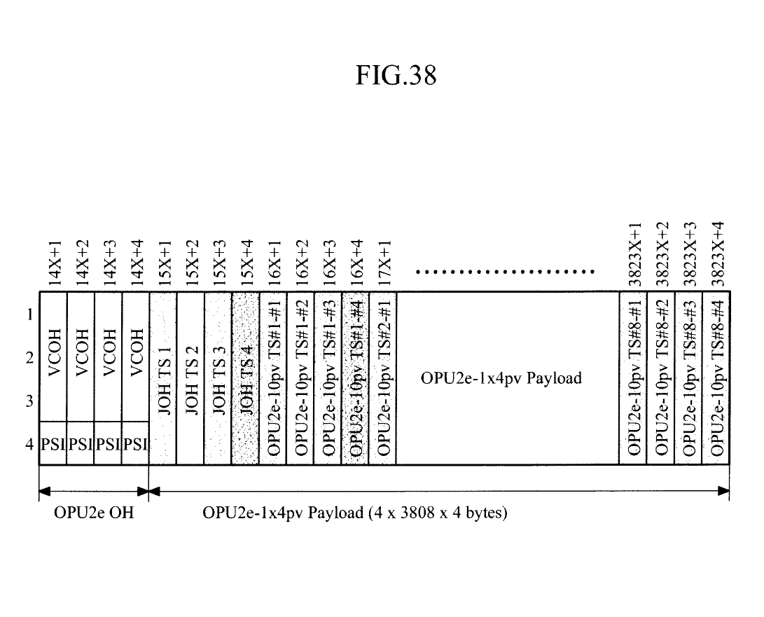

PMSI coding for pseudo-inverse multiplexing two 10GbE signals and two 40GbE signals has been described above with reference to FIG. 32. The two 10GbE signals are mapped to tributary slots TS-#6 and TS-#8, respectively, and the two 40GbE signals are mapped to tributary slots (TS-#1, TS-#2 TS-#3 and TS-#4) and (TS-#5, TS-#7, TS-#9 and TS-#10), respectively. The resultant pseudo-inverse multiplexed frame structures are shown in FIGS. 38 through 41.

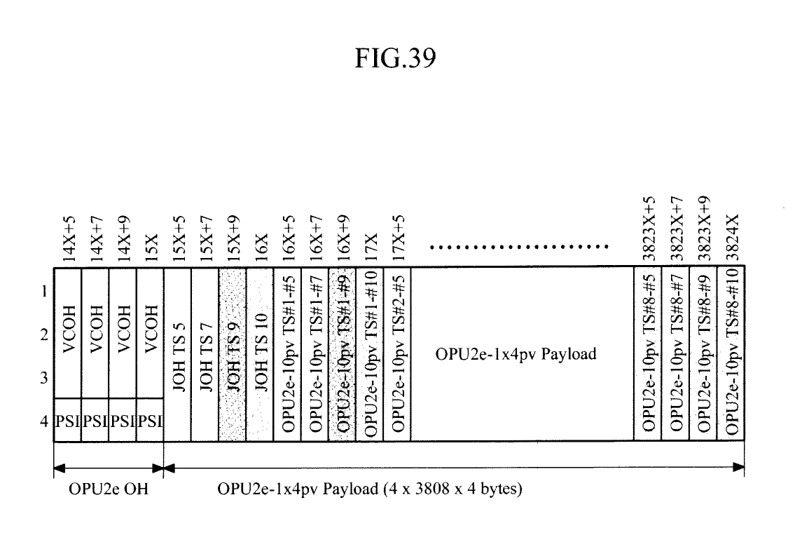

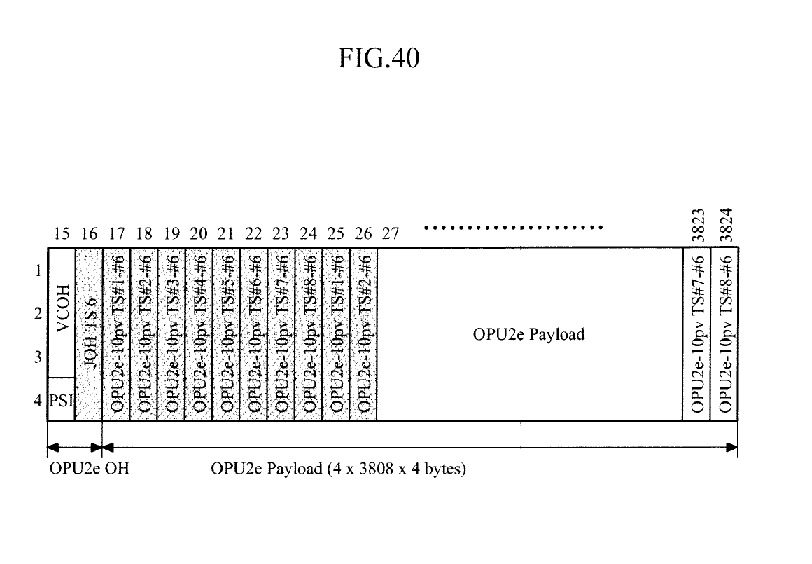

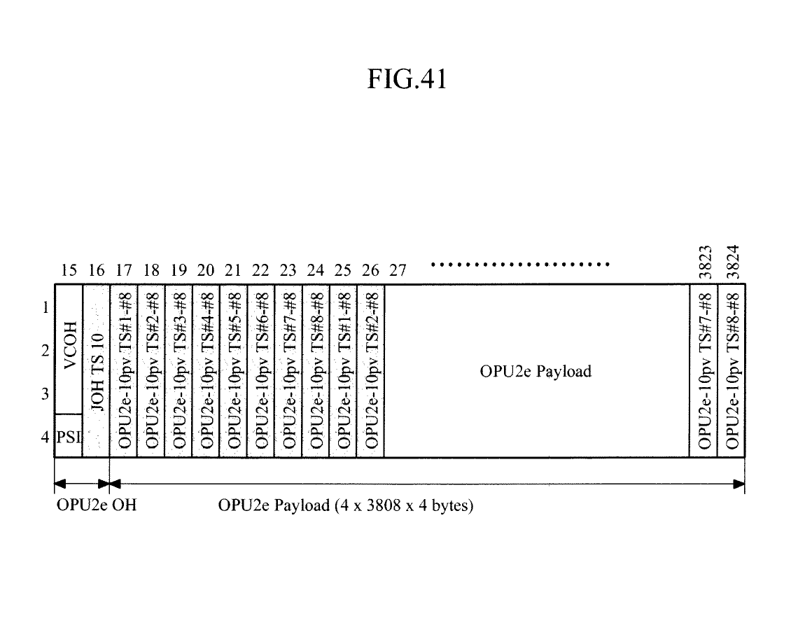

FIG. 38 shows a pseudo-inverse multiplexed frame OPU2e-1x4v composed of OPU2e tributary slots TS-#1, TS-#2, TS-#3 and TS-#4 in OPU2e-10pv. In the expression “OPU2e-1x4v”, “OPU2e-1x” means one tributary slot and “4v” indicates that 4 OPU2e tributary slots are virtually concatenated. Likewise, FIG. 39 shows a pseudo-inverse multiplexed frame OPU2e-1x4v composed of OPU2e tributary slots TS-#5, TS-#7, TS-#9 and TS-#10 in OPU2e1-10pv. FIG. 40 shows an OPU2e-1x1v frame composed of a tributary slot TS-#6, and FIG. 41 shows an OPU2e-1x1v frame composed of a tributary slot TS-#8.

As seen in FIGS. 38 through 41, two 10GbE signals and two 40GbE signals are mapped to pseudo-inverse frames, respectively, and transported through 10 OTU2e tributary slots. A receiving terminal receives the signals to form OPU2e-10pv and performs pseudo-inverse de-multiplexing on the OPU2e-10pv, thus extracting two 10GbE signals and two 40GbE signals.

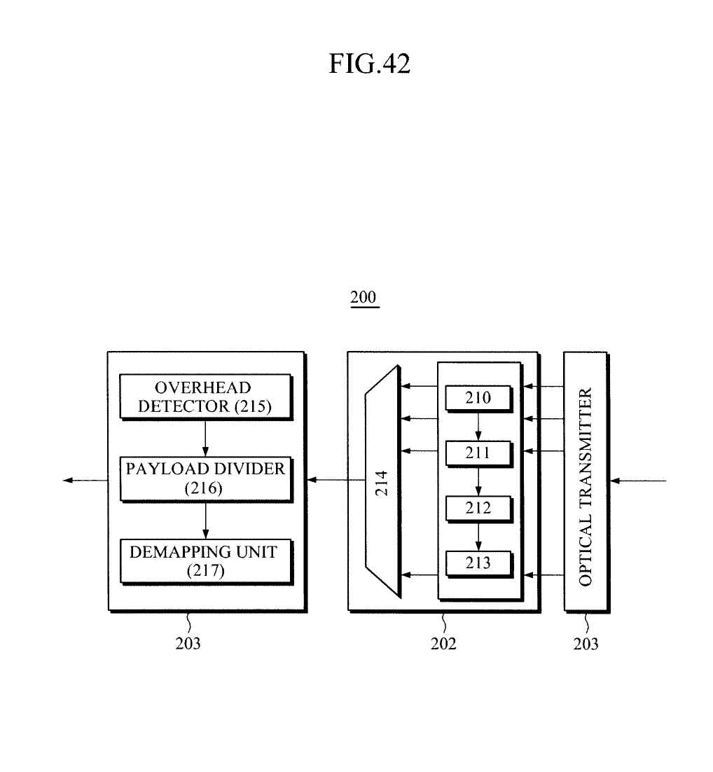

FIG. 42 is a block diagram illustrating a configuration of a pseudo-inverse de-multiplexer 200.

Referring to FIG. 42, the pseudo-inverse de-multiplexer 200 includes an optical receiver 201, an OTUk-Xpv processor 202 and an OPUk-Xpv processor 203.

For example, the optical receiver 201 corresponds to the parallel 10×10G optic module of FIG. 8, the OPUk-Xpv processor 202 can receive OTU2e signals and restore OPU2e-10v frames, and the OPUk-Xpv processor 203 can extract client signals from the OPU2e-10pv frames.

That is, the optical receiver 201 receives optical signals over an optical transport network (OTN), performs X multiple bit-demultiplexing on the optical signals to convert into electrical signals and then transfers the electrical signals to the OPUk-Xpv processor 202. The OPUk-Xpv processor 202 restores OPUk-Xpv frames from X received OTU signals. The OPUk-Xpv processor 203 demaps the OPUk-Xpv frames, thus extracting client signals.

In detail, the OTUk-Xpv processor 202 may include a frame level setting unit 210, a frame and virtual-concatenation detection unit 211, a skew compensation unit 212, an OTU/ODU overhead extraction unit 213 and a multiplexer 214.

The frame level setting unit 210 sets a level k of OTUk for an OTUk-Xpv frame. The level k may be set by a user or detected from a signal reception rate of the optical receiver 201. Or, it is also possible to install frame detectors for respective k values and read the k values from detected frames.

The frame and virtual-concatenation detection unit 211 detects frames from signals received by the optical receiver 201, and then detects the virtual concatenation number X by recognizing a total number of TVI bytes or SQ bytes of the frames. Also, if X frames are detected from Y frame detectors, the frame and virtual-concatenation detection unit 211 can analogize the number of virtual concatenated payloads to X. However, if the detected number of frames is not identical to the number of virtual concatenated payloads due to errors, etc., the frame and virtual-concatenation detection unit 211 outputs an alert informing that signal fail has occurred in the OTUk-Xpv signal. Alternatively, the number of virtually concatenated payloads may be set by a user and in this case, the function of detecting the number of virtually concatenated payloads may be omitted.

The skew compensation unit 212 performs skew compensation and arrangement on the corresponding OTU frames and the number X of virtually concatenated payloads detected by the frame and virtual concatenation detection unit 211. The skew compensation unit 212 detects skew values of the X received OTU signals, occurred during transmission, using MFAS, MFI, etc., and compensates for the skew values using a delay shifter, etc. Also, the skew compensation unit 212 arranges the X OTU frames sequentially according to the detected number of SQ bytes.

The OTU/ODU overhead extraction unit 213 extracts OTU and ODU overheads from the X OTU signals arranged by the skew compensation unit 212, generates OPUk#1 through OPUk#n frames and then multiplexes the OPUk#1 through OPUk#n frames through the multiplexer 214 to restore OPUk-Xpv frames.

In more detail, the OPUk-Xpv processor 203 may include an overhead detector 215, a payload divider 216 and a demapping unit 217.

The overhead detector 215 detects PT and VcPT values from the overhead of an OPUk-Xpv frame. The overhead detector 215 determines the type of tributary slots forming the OPUk-Xpv frame according to the PT value. OPUk-Xv tributary slots, OPUk tributary slots and 1.25G tributary slots may be applied to OPUk-Xpv frames. In some cases, since two or more types of tributary slots may form an OPUk-Xpv frame, the overhead detector 215 has to be able to detect a PT value for each frame.

Also, the overhead detector 215 detects the number of tributary slots that are used. In the case of an OPUk-Xv tributary slot type, the overhead detector 215 can easily detect the number of tributary slots as 1 since the OPUk-Xv tributary slot type has a client signal and an OPUk-Xv tributary slot. In the case of an OPUk tributary slot type, first, the number of virtual concatenated tributary slots is detected using PMSI bytes. Also, the number of 1.25G tributary slots that are used in the OPUk tributary slots is detected using MSI bytes. Accordingly, it is possible to determine how many client signals are mapped to OPUk-Xpv based on the number of virtual concatenated OPUk tributary slots and the number of 1.25G tributary slots. If no OPU2e tributary slot is virtually concatenated in the OPU2e-10v frame and no 1.25G tributary slot in the OPU2e tributary slots is multiplexed, this means that client signals are mapped individually to 8 1.25G tributary slots in each OPU2e tributary slot map. When a 1.25G tributary slot type is used, how many 1.25G tributary slots are multiplexed may be determined based on MSI bytes. If the MSI values of 32 1.25G tributary slots in an OPU3e-3v frame are the same, this means that the 32 1.25G tributary slots have been multiplexed. Also, it is possible to recognize the number of a 1.25G tributary slot used to map a client signal.

The payload divider 216 divides the OPUk-Xpv frame using the detected tributary slot type and the detected number of tributary slots.

The demapping unit 217 demaps client signals from the divided tributary slots. The demapping unit 217 determines whether justification has occurred between the client signals and tributary slots based on justification overhead information corresponding to the tributary slots, particularly, based on JC information, and extracts a bit rate of the client signals according to the result of the determination.

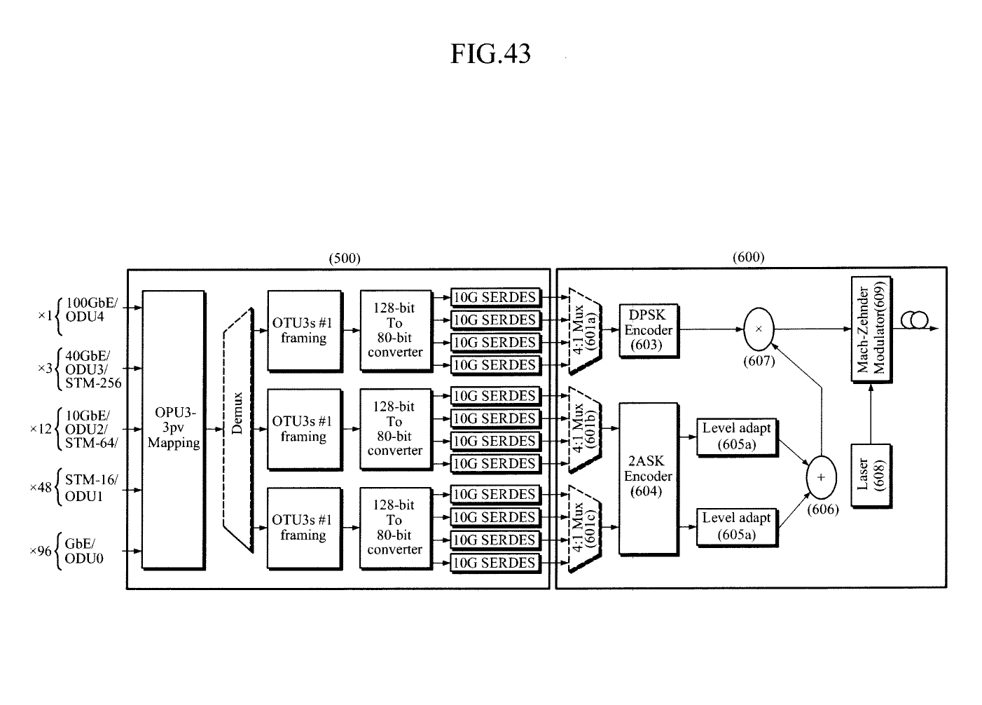

FIG. 43 illustrates interfaces between a pseudo-inverse multiplexer 500 and an optical transporter 600, according to an exemplary embodiment.

The number of interfaces may be determined according to a level k of OPUk-Xpv and the number X of virtually concatenated slots. For example, the interface may be m*X 100G interfaces, m/2*X 20G interfaces or m/3*X 30G interfaces. Here, m depends on the k value. For example, m is 1 if k=2, m is 4 if k=3, m is 10 if k=4 and m is 40 if k=5.

The 120G optical transporter 600 receives 12 10G-level electrical signals from the OTU3-3pv pseudo-inverse multiplexer 500, generates a 43G-level electrical signal using 4 10G electrical signals of the 12 10G electrical signals through a 43G-level 4:1 MUX 601a and transfers the 43G-level electrical signal to a DPSK encoder 603.

Then, the 120G optical transporter 600 generates 43G-level electrical signals using the remaining 8 10G-level electrical signals through 4:1 MUX 601b and 601b, and then transfers the 43G-level electrical signals to a 2ASK encoder 604. The 2ASK encoder 604 encodes the two 43G-level signals received from the 43G 4:1 MUX 601b and 602c to generate two successive 2-level symbols.

The amplitudes of the generated two 43G-level electrical signals are adjusted by two level adapters 605a and 605b to reduce interferences of the 43G-level electrical signals to the maximum. The resultant 43G-level electrical signals are summed by a summer 606, thus generating a 2ASK electrical signal. The 2ASK electrical signal and a DPSK electrical signal generated by a DSPK encoder 603 are transferred to a multiplier 607 to generate a DPSK-2ASK electrical signal, and the DPSK-2ASK electrical signal is transferred to the optical modulator 609. The optical modulator 609 applies the DPSK-2ASK electrical signal to a continuous wave optical signal received from a laser 608 to finally generate a DPSK-2ASK modulated optical signal, and transmit a 120G-level optical signal for each wavelength channel.

The current embodiment is described based on an exemplary modulation method, but various modulation methods can be used which can transmit 3 bits as a symbol. For example, such 3-bit transmission may be performed by a simple 4:1 MUX.

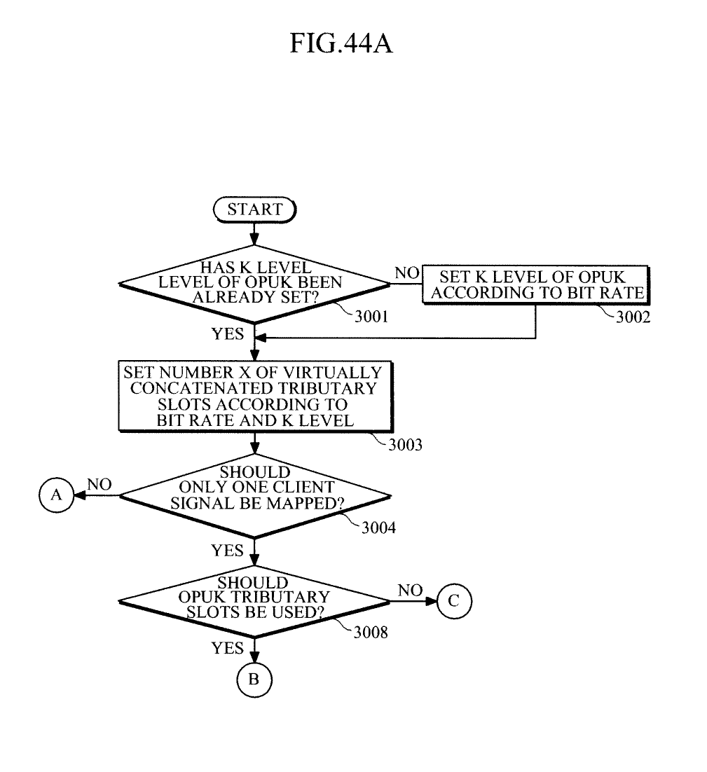

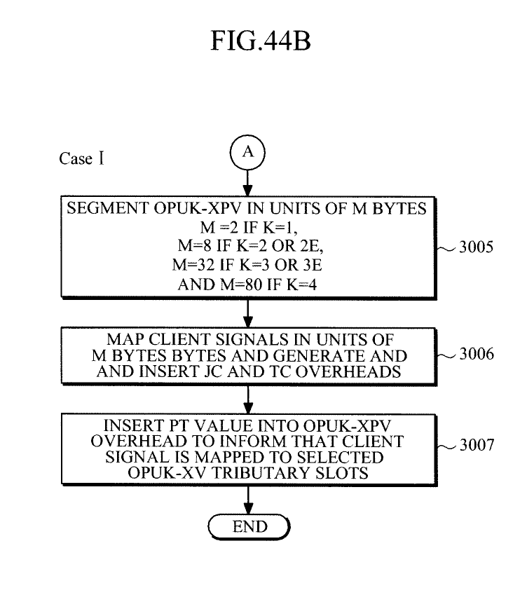

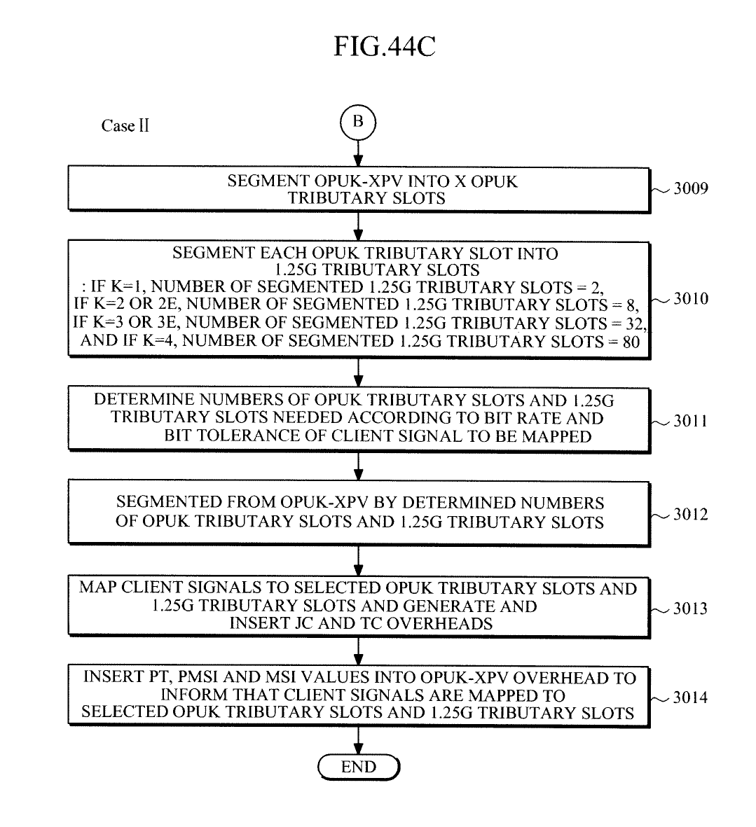

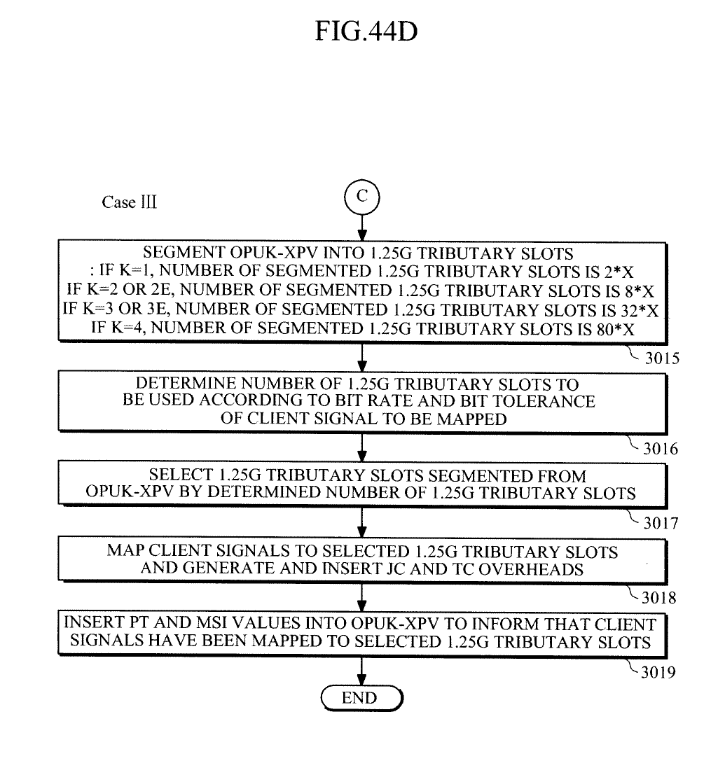

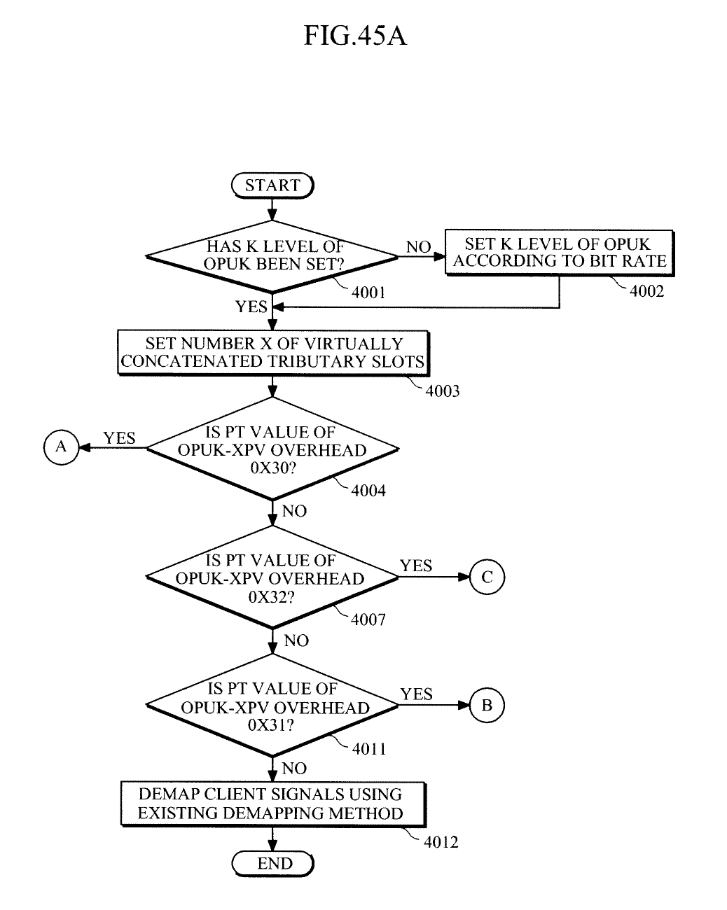

FIGS. 44A through 44D are a flowchart illustrating a pseudo-inverse multiplexing method according to an exemplary embodiment.

Referring to FIGS. 44A through 44D, a pseudo-inverse multiplexer (for example, see FIG. 14) determines whether a k level of OPUk is set (operation 3001). If no k level is set, a k level of OPUk is set according to a bit rate of the OPUk (operation 3002). After the k level is set, a virtual concatenation number is determined according to the bit rate and the k level (operation 3003). Accordingly, the number of OTU frames to be used and the number of optic modules to transmit the respective OTU frames can be recognized.

Thereafter, the pseudo-inverse multiplexer determines whether only one client signal is mapped (operation 3004). If one client signal is mapped, an OPUk-Xv tributary slot type is used (case I).

If an OPUk-Xv tributary slot type is determined to be used, an OPUk-Xv tributary slot is segmented in units of M bytes (operation 3005). If k=1, M is 2 and if k=2 or 2e, M is 8. Likewise, if k=3 or 3e, M is 32 and if k=4, M is 80.

Then, the client signal is mapped to the OPUk-Xv tributary slots segmented in units of M bytes, and then JC and TC overheads are generated (operation 3006).

Then, in order to inform the fact that the client signal is mapped to the OPUk-Xv tributary slots, a PT value is inserted into an OPUk-Xpv overhead and the OPUk-Xpv signal is transmitted to the OTUk-Xpv processor (operation 3007).

If a plurality of client signals are mapped, it is determined whether to use OPUk tributary slots (operation 3008). OPUk tributary slots are used to map OPUk-based client signals (case II).

If it is determined that an OPUk tributary slot type has to be used, OPUk-Xpv is segmented into X OPUk tributary slots (operation 3009).

Thereafter, each OPUk tributary slot is segmented into 1.25G tributary slots (operation 3010). If k=1, the number of the segmented 1.25G tributary slots is 2, and if k=2 or 2e, the number of the segmented OPUk tributary slots is 8. Likewise, if k=3 or 3e, the number of the segmented OPUk tributary slots is 32 and if k=4, the number of the segmented OPUk tributary slots is 80.

Then, the number of OPUk tributary slots to be used and the number of 1.25G tributary slots to be used are determined according to a bit rate and bit tolerance of a client signal to be mapped (operation 3011).

Next, using the determined number TS, the client signals are mapped to the OPUk or 1.25G tributary slots (operation 3012). Here, if another client signal has to be mapped using the OPUk tributary slots or 1.25G tributary slots, some of the OPUk or 1.25G tributary slots are allocated to the client signal without overlapping.

Then, client signals are mapped to the selected OPUk tributary slots and 1.25G tributary slots, and JC and TC overheads are generated and inserted (operation 3013).

Successively, in order to inform the fact that the client signals have been mapped to the selected OPUk tributary slots and 1.25G tributary slots, PT, PMSI and MSI values are inserted into the OPUk-Xpv overheads, and the resultant OPUk-Xv signal is transmitted to the OTUk-Xpv processor (operation 3014).

If it is determined that a 1.25G tributary slot type has to be used (case III), OPUk-Xpv is segmented into 1.25G tributary slots (operation 3015). Here, if k=1, the number of the segmented 1.25G tributary slots is 2*X, and if k=2 or 2e, the number of the segmented 1.25G tributary slots is 8*X. Likewise, if k=3 or 3e, the number of the segmented 1.25G tributary slots is 32*X, and if k=4, the number of the segmented 1.25G tributary slots is 80*X.

Thereafter, the number of 1.25G tributary slots to be used is determined according to a bit rate and bit tolerance of a client signal to be mapped (operation 3016).

Then, 1.25G tributary slots segmented from OPUk-Xpv are selected by the determined number of 1.25G tributary slots (operation 3017). Here, if another client signal has to be mapped using the 1.25G tributary slots, some of the OPUk or 1.25G tributary slots are allocated to the client signal without overlapping.

Successively, client signals are mapped to the selected 1.25G tributary slots, and JC and TC overheads are generated and inserted (operation 3018).

Then, in order to inform the fact that the client signals have been mapped to the selected 1.25G tributary slots, PT and MSI values which are OPUk-Xpv overheads are inserted into the OPUk-Xpv signal, and the resultant OPUk-Xpv signal is transmitted to the OPUk-Xpv processor (operation 3019).

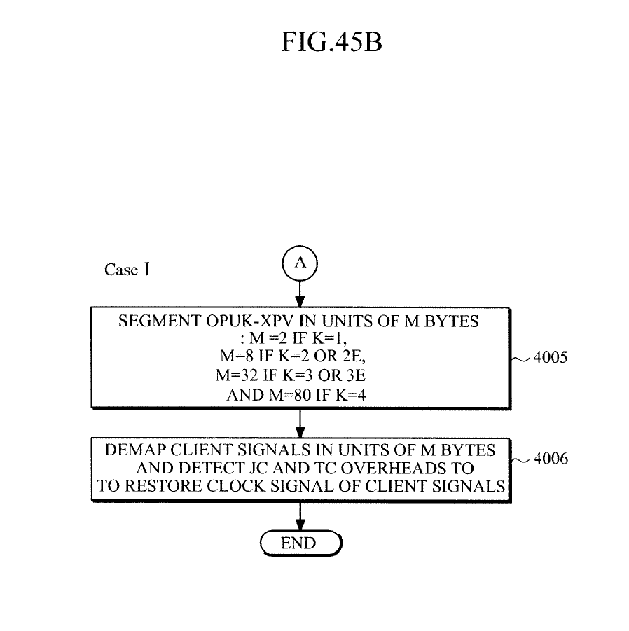

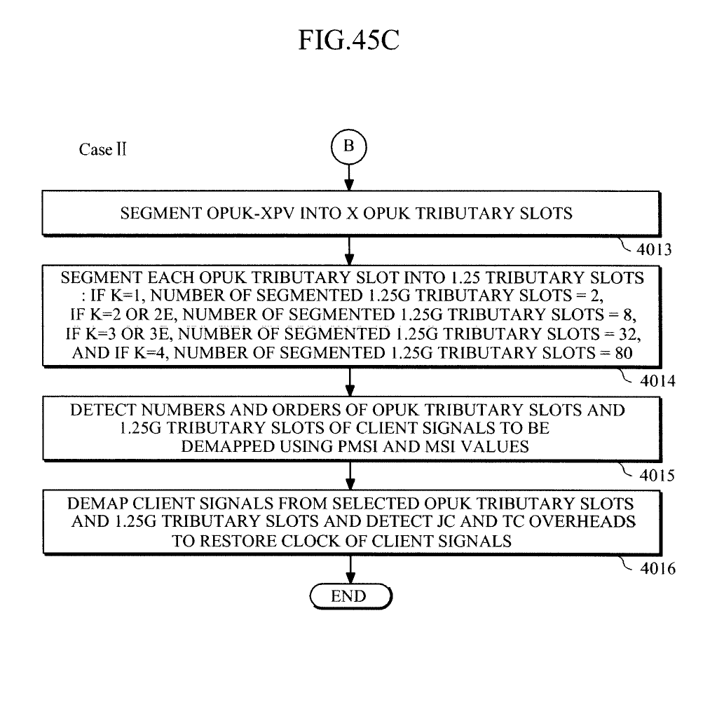

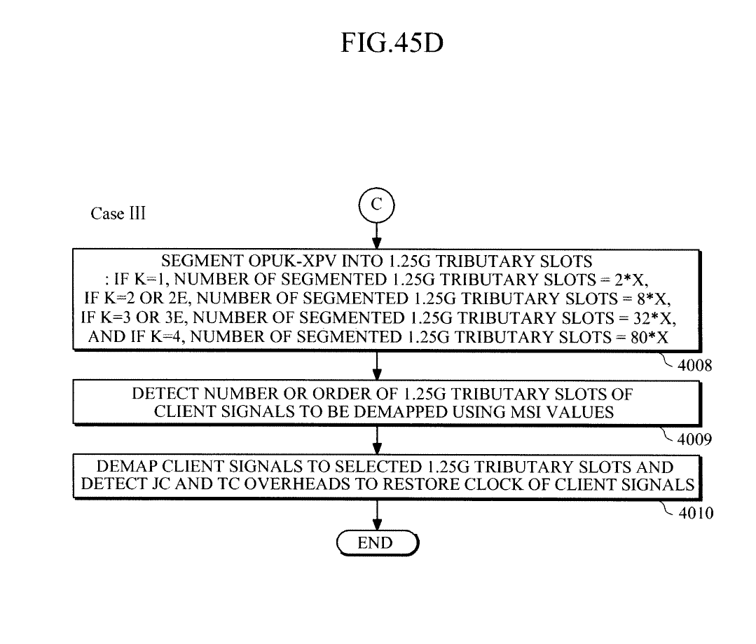

FIGS. 45A through 45D are a flowchart illustrating a pseudo-inverse de-multiplexing method according to an exemplary embodiment.

Referring to FIGS. 45A through 45D, the pseudo-inverse de-multiplexer (see FIG. 42) determines whether a k level of OPUk has been set (operation 4001). If no k level has been set, a k level of OPUk is set in correspondence to a predetermined bit rate (operation 4002). If a k value has been already set, the number X of virtual concatenated slots is determined (operation 4003). Accordingly, the number of OTU frames that are received and the number of optic modules that are to receive the respective OTU frames can be decided.

Then, it is determined whether a PT value corresponding to an overhead of the received OPUk-Xpv signal is 0x30 (operation 4004). If the PT value is 0x30, it is determined that an OPUk-Xv tributary slot type has been used.

If it is determined that an OPUk-Xv tributary slot type has been used, each OPUk-Xv frame is segmented according to the k level (operation 4005). If k=1, M is 2 and if k=2 or 2e, M is 8. Likewise, if k=3 or 3e, M is 32 and if k=4, M is 80.

Then, client signals are demapped from the OPUk-Xv tributary slots, and JC and TC overheads are detected to determine whether justification has been occurred between the client signals and the tributary slots, and then a clock signal of the client signals is restored (operation 4006).

If the PT value is not 0x30, it is determined whether the PT value is 0x32 (operation 4007). If the PT value is 0x32, it is determined that a 1.25G tributary slot type has been used.

If it is determined in operation 4007 that a 1.25G tributary slot type has been used, OPUk-Xpv is segmented into 1.25G tributary slots (operation 4008). Here, if k=1, the number of the segmented 1.25G tributary slots is 2*X, and if k=2 or 2e, the number of the segmented 1.25G tributary slots is 8*X. Likewise, if k=3 or 3e, the number of the segmented 1.25G tributary slots is 32*X, and if k=4, the number of the segmented 1.25G tributary slots is 80*X.

Then, the number or order of 1.25G tributary slots of client signals to be demapped are calculated using a MSI value detected from an OPUk-Xpv overhead (operation 4009). At this time, it can be determined how many client signals are mapped to the 1.25G tributary slots based on the MSI value.

Then, the client signals are demapped form the 1.25G tributary slots, JC and TC overheads are detected to determine whether Justification has been occurred between the client signals and the tributary slots, and then a clock signal of the client signals are restored (operation 4010).

If it is determined in operation 4007 that the PT value is not 0x32, it is determined whether the PT value is 0x31 (operation 4011). If the PT value is 0x31, it is determined that an OPUk tributary slot type has been used.

Meanwhile, if the PT value is 0x31, client signals are demapped using an existing demapping method according to the corresponding PT value (operation 4012).

If it is determined in operation 4011 that the OPUk tributary slot type has been used, the OPUk-Xpv is segmented into X OPUk tributary slots (operation 4013).

Then, each OPUk tributary slot is segmented into 1.25G tributary slots (operation 4014). Here, if k=1, the number of the segmented 1.25G tributary slots is 2, and if k=2 or 2e, the number of the segmented 1.25G tributary slots is 8. Likewise, if k=3 or 3e, the number of the segmented 1.25G tributary slots is 32, and if k=4, the number of the segmented 1.25G tributary slots is 80.

Then, the numbers and orders of OPUk tributary slots and 1.25G tributary slots of client signals to be demapped are calculated using PMSI and MSI values detected from the OPUk-Xpv overhead (operation 4015). At this time, it can be determined how many client signals have been mapped in an OPUk tributary slot based on a MSI value. Also, it can be determined how many client signals have been mapped based on a PMSI value

Successively, client signals are demapped from the selected OPUk tributary slots and 1.25G tributary slots, JC and TC overheads are detected to determine whether Justification has occurred between the client signals and tributary slots, and then a clock signal of the client signals is restored (operation 4016).

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. A pseudo-inverse multiplexing apparatus comprising:
a frame setting unit to determine a type of a tributary slot to map a client signal and to segment a virtual concatenated optical channel payload unit (OPUk-Xpv) into at least one tributary slot according to the determined tributary slot type;
a payload generator to map a received client signal to a payload of the OPUk-Xpv, using the tributary slot; and
an overhead generator to generate frame configuration information related to the to tributary slot and to insert the frame configuration information into an overhead of the OPUk-Xpv.

2. The pseudo-inverse multiplexing apparatus of claim 1, wherein the frame setting unit segments the OPUk-Xpv into an OPUk-Xv tributary slot that is segmented in units of a predetermined number of bytes, into X OPUk tributary slots each of which is segmented into a predetermined number of 1.25G tributary slots, or into a plurality of 1.25G tributary slots.

3. The pseudo-inverse multiplexing apparatus of claim 2, wherein a capacity of the tributary slot and the predetermined unit of bytes are determined according to a level k of the OPUk-Xpv.

4. The pseudo-inverse multiplexing apparatus of claim 1, wherein the payload generator decides the number of tributary slots needed to map the client signal, according to a bit rate or a bit tolerance of the client signal.

5. The pseudo-inverse multiplexing apparatus of claim 4, wherein the payload generator allocates received client signals to different tributary slots.

6. The pseudo-inverse multiplexing apparatus of claim 1, wherein the frame configuration information includes at least one among the determined tributary slot type, the number of tributary slots used for mapping, justification control information and timing control information.

7. The pseudo-inverse multiplexing apparatus of claim 1, further comprising an interface to transfer an optical channel transport unit (OTU) corresponding to the OPUk-Xv to an optical transporter,
wherein the interface includes a plurality of interface units depending on a level k of the OPUk-Xv and a virtual concatenation number X.

8. A pseudo-inverse multiplexing method comprising:
determining a type of a tributary slot to map a client signal, and segmenting a virtual concatenated optical channel payload unit (OPUk-Xpv) into at least one tributary slot based on the determined tributary slot type;
mapping a received client signal to a payload of the OPUk-Xpv using the tributary slot; and
generating frame configuration information related to the tributary slot and inserting the frame configuration information into an overhead of the OPUk-Xpv.

9. The pseudo-inverse multiplexing method of claim 8, wherein the tributary slot is at least one of an OPUk-Xv tributary slot that is segmented in units of a predetermined number of bytes, X OPUk tributary slots each of which is segmented into a predetermined number of 1.25G tributary slots, or a plurality of 1.25G tributary slots.

10. The pseudo-inverse multiplexing method of claim 9, wherein a capacity of the OPUk-Xv tributary slot and the predetermined unit of bytes are determined according to a level k of the OPUk-Xpv.

11. The pseudo-inverse multiplexing method of claim 8, wherein the mapping of the payload comprises deciding the number of tributary slots needed to map the client signal, according to a bit rate or a bit tolerance of the client signal.

12. The pseudo-inverse multiplexing method of claim 11, wherein the mapping of the payload comprises allocating received client signals to different tributary slots.

13. The pseudo-inverse multiplexing method of claim 8, wherein the frame configuration information includes at least one among the determined type of the tributary slot, the number of tributary slots used for mapping, justification control information and timing control information.

14. A pseudo-inverse de-multiplexing apparatus comprising:
an overhead detection unit to detect a type and number of tributary slots to which client signals have been mapped, using an overhead of a received virtual concatenated optical channel payload unit (OPUk-Xpv);
a payload segmentation unit to segment the OPUk-Xpv into the tributary slots according to the detected type and number of the tributary slots; and
a demapping unit to detect the client signals according to the tributary slots.

15. The pseudo-inverse de-mapping apparatus of claim 14, wherein each of the tributary slots is at least one among an OPUk-Xv tributary slot that is segmented in units of a predetermined number of bytes, X OPUk tributary slots each of which is segmented into a predetermined number of 1.25G tributary slots, or a plurality of 1.25G tributary slots.

16. The pseudo-inverse de-mapping apparatus of claim 15, wherein a capacity of the tributary slot and the predetermined unit of bytes are determined according to a level k of the OPUk-Xpv.

17. The pseudo-inverse de-mapping apparatus of claim 14, wherein the overhead includes at least one among the determined type of tributary slots, the number of tributary slots used for mapping, justification control information and timing control information.

18. A pseudo-inverse de-multiplexing method comprising:
detecting a type and number of tributary slots to which client signals have been mapped, using an overhead of a received, virtually concatenated optical channel payload unit OPUk-Xpv;
segmenting the OPUk-Xpv into the tributary slots based on the detected type and number of the tributary slots; and
detecting the client signals according to the tributary slots.

19. The pseudo-inverse de-multiplexing method of claim 18, wherein each of the tributary slots is at least one among an OPUk-Xv tributary slot that is segmented in units of a predetermined number of bytes, X OPUk tributary slots each of which is segmented into a predetermined number of 1.25G tributary slots, or a plurality of 1.25G tributary slots.

20. The pseudo-inverse de-multiplexing method of claim 19, wherein a capacity of the tributary slot and the predetermined unit of bytes are determined according to a level k of the OPUk-Xpv.
